(19) United States
(12) Patent Application Publication
(10) Pub. No.: US 2017/0190344 A1
(43) Pub. Date: Jul. 6, 2017

(54) Industrial Cart

(71) Applicant: Troy James Bengtzen, Holladay, UT (US)

(72) Inventor: Troy James Bengtzen, Holladay, UT (US)

(21) Appl. No.: 15/179,572

(22) Filed: Jun. 10, 2016

Related U.S. Application Data
(60) Provisional application No. 62/274,718, filed on Jan. 4, 2016.

(51) Int. Cl. B62B 3/02; B62B 5/00; B62B 5/06; B62B 3/10

(52) U.S. Cl. CPC B62B 3/025; B62B 3/10; B62B 5/0003; B62B 5/06; B62B 2202/48

(57) ABSTRACT

A cart has a frame having a pair of elongate side frame members and a cargo-supporting framework having a plurality of supporting ribs, each supporting rib being connected to and extending approximately downward from one side frame member, and a horizontal support structure interconnecting the plurality of supporting ribs. The cart may include at least one of 1) a rigid support member resting on and supported by the horizontal support structure, 2) a containment pan connected to and suspended under the cargo-supporting framework, and 3) a foldable trailer hitch connected to the cart and configured to permit towing of the cart by a vehicle. At least one of the side frame members and the containment pan may include openings, sleeves, or stepped portions configured to receive forks of a forklift to permit lifting of the cart by the forklift, even when loaded.

### CROSS-REFERENCE TO RELATED APPLICATIONS

This application is related to U.S. Provisional Application Ser. No. 62/274,718 filed January, 2016, which is incorporated herein by reference in its entirety.

### BACKGROUND OF THE INVENTION

1. Field of the Invention

The present invention relates to carts, and more particularly to a multi-functional industrial cart.

2. Background and Related Art

In industrial settings, there is often a need to move various objects and materials from one location to another. In many instances, the items and materials to be moved can be relatively small, quite heavy, sensitive to damage, and/or bulky. In addition, in some instances, the items and materials to be moved may contain potentially-hazardous and/or messy materials such as oil and the like. For example, in the oil refining and processing industry, relatively-small and heavy precision equipment, tooling, or instrumentation may need to be moved within an industrial plant site. Improper handling of such equipment, tooling, or instrumentation can result in injuries to personnel, damage to equipment, and environmental issues. One specific example of an object that may need to be moved in such an environment is a valve. Such valves may weigh hundreds of pounds, but may be small enough that it may be difficult for more than two people to simultaneously hold and carry the valves when they need to be moved from one location to another, such as to facilitate replacement of a faulty valve.

There is no comprehensive, safe, efficient, protective, or cost-effective device to move such items. When personnel try to physically carry such items, they subject themselves to risk of injury due to strain and/or inadvertent dropping of the items. In addition, when such items are carried, they may leak hazardous materials such as oil products as they are carried from one location to another. Some such items may be broken or damaged if dropped. The distances such objects must be transported can be quite large, and manually carrying such items may require rest stops and setting the objects down may result in the objects becoming dirty and/or damaged.

Such difficulties have been recognized, and attempts have been made to address such difficulties, such as by using existing flatbed carts to transport such items. Such attempts have been less than satisfactory for multiple reasons. For example, such carts have failed to fully address the need to contain potentially-hazardous materials that may leak from the carried objects. Additionally, in many environments such carts have proved difficult to use, such as when encountering a need to move between multiple levels of a plant structure or across uneven terrain. In some instances, items or materials are prone to fall off such carts during transport, which may lead to damage to the items, spillage of hazardous materials, and possible injury.

### BRIEF SUMMARY OF THE INVENTION

Implementation of the invention provides a cart having a frame having a pair of elongate side frame members. The cart further includes a cargo-supporting framework having a plurality of supporting ribs, each supporting rib being connected to and extending approximately downward from one side frame member and a horizontal support structure interconnecting the plurality of supporting ribs. The cart also includes a rigid support member resting on and supported by the horizontal support structure.

Further implementation of the invention provides a cart having a frame having a pair of elongate side frame members. The cart further includes a cargo-supporting framework having a plurality of supporting ribs, each supporting rib being connected to and extending approximately downward from one side frame member and a horizontal support structure interconnecting the plurality of supporting ribs. The cart also includes a containment pan connected to and suspended under the cargo-supporting framework.

Further implementation of the invention provides a cart having a frame having a pair of elongate side frame members. The cart further includes a cargo-supporting framework having a plurality of supporting ribs, each supporting rib being connected to and extending approximately downward from one side frame member and a horizontal support structure interconnecting the plurality of supporting ribs. In the implementation, the side frame members include openings configured to receive forks of a forklift to permit lifting of the cart by the forklift.

Further implementation of the invention provides a cart having a handle at an ergonomic height configured to permit pushing or pulling of the cart. The cart further includes an extendible and foldable trailer hitch connected to the cart and configured to permit towing of the cart by a vehicle.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a perspective view of a frame of a cart embodiment;

FIG. 2 shows a perspective underside view of the frame of FIG. 1;

FIG. 3 shows a perspective underside view of the frame of FIG. 1 with wheels attached;

FIG. 4 shows a side view of the structure of FIG. 3;

FIG. 5 shows a perspective view of the structure of FIG. 3 with a rigid support member included;

FIG. 6 shows a perspective view of the structure of FIG. 5 with screw jacks or stabilizers attached thereto;

FIG. 7 shows a perspective view of the structure of FIG. 6 with a containment pan attached thereto;

FIG. 8 shows a perspective view of the structure of FIG. 7 with the containment pan detached from the remaining structure;

FIG. 9 shows a side view of the structure of FIG. 8;

FIG. 10 shows a perspective view of an alternative containment pan;

FIG. 11 shows a perspective view the structure of FIG. 7 with a tow hitch attached thereto and folded up;

FIG. 12 shows a perspective view the structure of FIG. 7 with a tow hitch attached thereto and extended;

FIG. 13 shows a perspective view of the structure of FIG. 11 with a first handle portion attached thereto;

FIG. 14 shows a perspective view of the structure of FIG. 13 with a handle tray attached thereto;

FIG. 15 shows a perspective view of the structure of FIG. 14 with a second handle portion attached thereto;

FIG. 16 shows a perspective view of the structure of FIG. 15 with a small workbench attached thereto;

FIG. 17 shows a perspective view of the structure of FIG. 16 with upper and lower brackets for securing stored table sections therein;

FIG. 18 shows an alternative perspective view of the structure of FIG. 17;

FIG. 19 shows a perspective view of the structure of FIG. 17 with table sections in a stored position;

FIG. 20 shows a perspective view of an illustrative table section;

FIG. 21 shows a perspective view of the structure of FIG. 17 with the table sections in a position for use;

FIG. 22 shows a close-up perspective view of a portion of FIG. 21;

FIG. 23 shows a perspective view of the structure of FIG. 21 with the addition of jack cranks to operate the screw jacks;

FIG. 24 shows various perspective views of a modular post;

FIG. 25 shows a perspective view of the structure of FIG. 19 with modular posts provided thereon;

FIG. 26 shows a perspective view of the structure of FIG. 19 showing modular post racks;

FIGS. 27-29 show embodiments of dedicated posts;

FIG. 30 shows a perspective view of the structure of FIG. 17 with side carry rack posts provided thereon;

FIG. 31 shows a perspective view of the structure of FIG. 21 with drink holder posts provided thereon;

FIG. 32 shows a perspective view of the structure of FIG. 19 with universal mounting plate posts provided thereon;

FIG. 33 shows a perspective view of a universal mounting plate post;

FIG. 34 shows a perspective view of the structure of FIG. 19 with a beam trolley hoist structure provided thereon;

FIG. 35 shows a perspective view of the structure of FIG. 34 with a canopy provided thereon;

FIG. 36 shows a perspective view of the structure of FIG. 35 with fabric of the canopy removed;

FIG. 37 shows a perspective view of the structure of FIG. 19 with a canopy structure provided thereon;

FIG. 38 shows a perspective view of the structure of FIG. 17 with a canopy storage container provided thereon;

FIGS. 39-40 show perspective views illustrating features of a canopy;

FIG. 41 shows a perspective view illustrating height-adjustment features of a trailer hitch;

FIG. 42 shows a perspective view illustrating features of a rear towing element and a stabilizing leg;

FIG. 43 shows a perspective view illustrating features of a mud flap/shock absorber;

FIG. 44 shows a side view illustrating features of a modified modular post;

FIG. 45 shows a perspective view illustrating extended functionality provided by horizontal extensions attached to modified modular posts;

FIG. 46 shows a perspective view illustrating use of a modified modular post to permit attachment of a welding curtain to a cart;

FIGS. 47-48 show perspective views illustrating a clipboard or document holder; and

FIG. 49 shows a perspective view of a modified beam trolley hoist attachment having forklift receiving holes.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide a cart having a frame having a pair of elongate side frame members. The cart further includes a cargo-supporting framework having a plurality of supporting ribs, each supporting rib being connected to and extending approximately downward from one side frame member and a horizontal support structure interconnecting the plurality of supporting ribs. The cart also includes a rigid support member resting on and supported by the horizontal support structure.

Further embodiments of the invention provide a cart having a frame having a pair of elongate side frame members. The cart further includes a cargo-supporting framework having a plurality of supporting ribs, each supporting rib being connected to and extending approximately downward from one side frame member and a horizontal support structure interconnecting the plurality of supporting ribs. The cart also includes a containment pan connected to and suspended under the cargo-supporting framework.

Further embodiments of the invention provide a cart having a frame having a pair of elongate side frame members. The cart further includes a cargo-supporting framework having a plurality of supporting ribs, each supporting rib being connected to and extending approximately downward from one side frame member and a horizontal support structure interconnecting the plurality of supporting ribs. In the embodiments, the side frame members include openings configured to receive forks of a forklift to permit lifting of the cart by the forklift.

Further embodiments of the invention provide a cart having a handle at an ergonomic height configured to permit pushing or pulling of the cart by hand. The cart further includes an extendible and foldable trailer hitch connected to the cart and configured to permit towing of the cart by a vehicle.

The Figures show various views of various portions and configurations of one embodiment of an industrial cart. The illustrated embodiment is in all respects intended to be illustrative of features of embodiments of the invention, and should not be understood to be limiting of the invention. Thus, for example, while the illustrated industrial cart is sized to be narrow enough to fit easily and maneuver on a standard catwalk as defined by the U.S. Occupational Safety and Health Administration (OSHA), thus being approximately thirty-two inches wide, and to be short enough to fit in older-style elevators found within plant structures, thus being approximately eighty inches long, these features are merely illustrative of one version or embodiment of the cart. The cart could be made longer or shorter, wider or narrower to satisfy any particular needs of any situation. The Figures are therefore intended to be illustrative of features of various embodiments.

The Figures are ordered and arranged to aid in discussing features of embodiments of the invention. Identical reference numbers are used to reference identical features throughout, but certain reference numbers may be omitted from certain Figures to aid in understanding features being discussed in reference to such Figures. The omission of any reference number from any Figure should not necessarily be interpreted to mean that such feature is not included or not visible in that particular Figure.

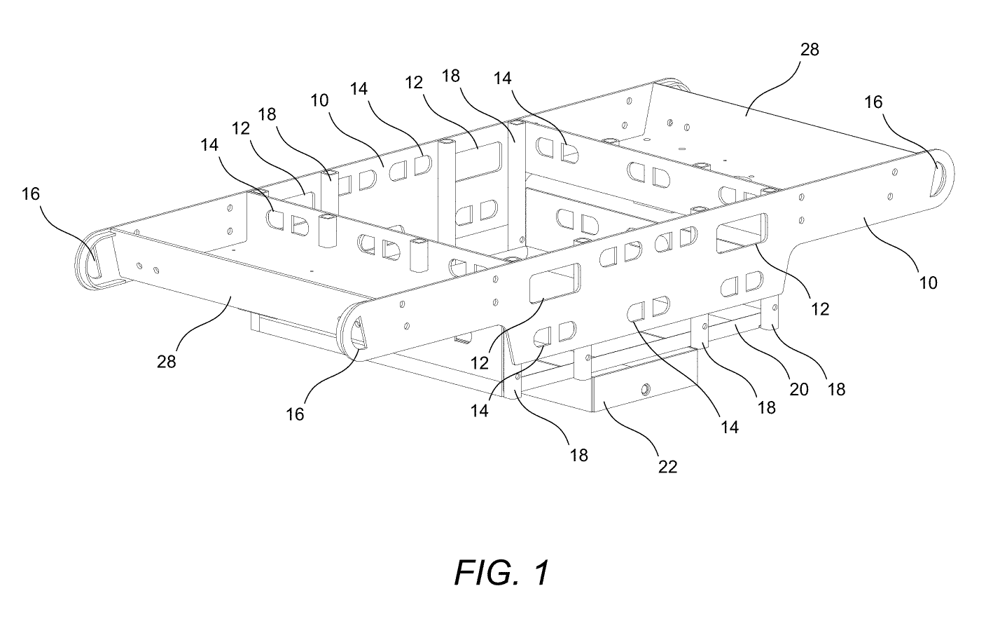

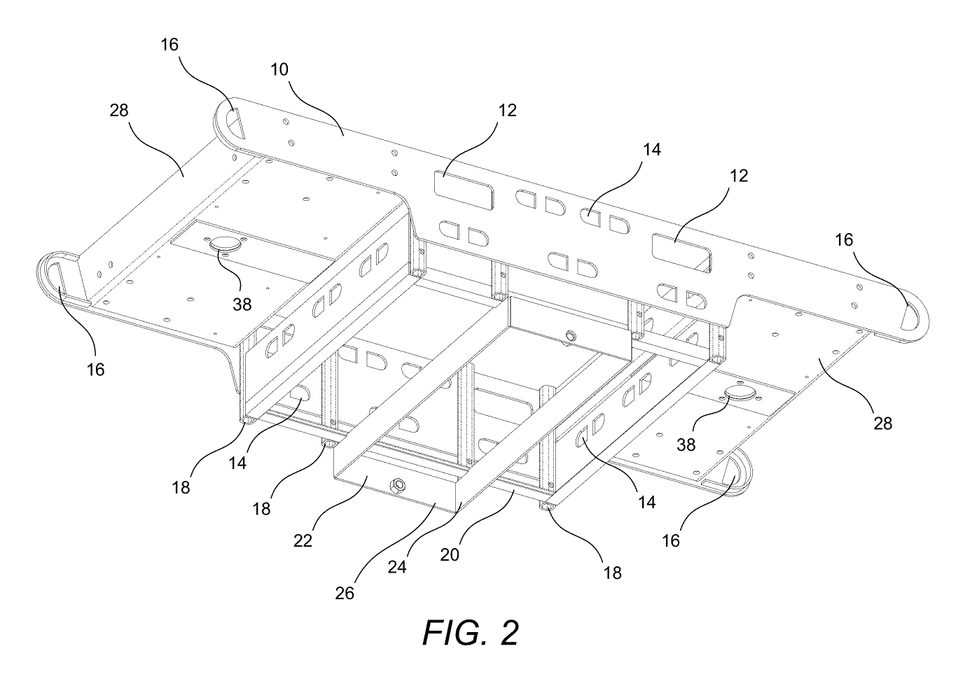

FIGS. 1 and 2 show perspective views of a primary frame portion of one embodiment of an industrial cart, and illustrates certain features thereof. The primary frame portion serves as a backbone of the cart, and also provides features facilitating various modes of transportation for the cart as well as facilitating carrying of various loads in and/or on the cart. The frame portion includes a pair of elongate side frame members 10. The side frame members 10 may be manufactured from any strong material, such as plate steel. The side frame members 10 each include a number of openings. Some large openings 12 are positioned to accept forklift forks whereby the cart (and certain contents) can at times be lifted and/or transported by a forklift. The large openings 12 allow the cart to be used to transport items or materials, including heavy loads, from one location to another across relatively-flat conditions and to then be lifted or lowered to a different vertical height by a forklift without removing any cargo in or on the cart. A forklift may also be used to readily transport the cart (loaded or empty) from one location to another without requiring that the cart be pushed or pulled by hand between locations.

The side frame members 10 also include small openings 14, which may be of any desirable size. The small openings 14 may also be located at other locations on the primary frame portion as illustrated in FIG. 1. The small openings 14 may serve any of a variety of purposes, including as a location for connecting a tie-down or other securing strap or device for securing cart contents to the cart. The small openings 14 may also be used as a connection point for a crane cable or other lifting device, allowing the cart to be readily transported between locations where rolling movement is not feasible, including locations not readily accessible using a forklift. Other options for similar transport will be discussed later with respect to other Figures. Of course, in some instances, the large openings 12 may also be used for some or all of the same purposes as the small openings 14. The side frame members 10 also include end openings 16, that may be used for any of the purposes discussed above with respect to the small openings 14. In addition, the end openings 16 (as well as the small openings 14 or large openings 12) may be used as a connection point for a tie-down when the cart is to be secured to a truck or trailer bed (or any other location) or the like for secure transportation, non-movement, or any other purposes.

The primary frame portion also includes a cargo-supporting framework that is visible in FIGS. 1-2. The cargo-supporting framework includes a plurality of supporting ribs 18 extending approximately downward from the elongate side frame members 10. The supporting ribs 18 shown in FIGS. 1 and 2 are tubular members having an open top end. Of course, it should be understood that the supporting ribs 18 may take various forms and need not be tubular members. In any instance where a tubular member having an open top end is discussed herein, it may be understood that the tubular member may also have an open bottom end to allow draining and minimize corrosion. An approximately-rectangular peripheral frame 20 is attached to the supporting ribs 18 at or near the bottom of the supporting ribs 18.

The peripheral frame 20 may be of any configuration sufficiently strong to support a rigid support member (e.g. a grating deck) thereon as will be discussed below. As one example, the peripheral frame 20 is formed of angle iron or angle steel such that each straight element of the peripheral frame 20 is composed of a vertical element disposed around the periphery of the peripheral frame 20 and a horizontal element disposed at the bottom of the peripheral frame 20. The horizontal elements of the peripheral frame 20 in this formation serve as an edge on which the rigid support member can rest. In this way, the peripheral frame 20 supports a peripheral edge of the rigid support member. If desired, the various members of the peripheral frame 20 may be cut or formed to make a precise fit to adjacent members at the corners of the peripheral frame 20.

It will be appreciated that it may be desirable to provide additional support to the central portions of the rigid support member, which may be formed of expanded metal, grating or other materials as will be discussed below. Without some additional support to the central portions of the rigid support member, the rigid support member may be prone to unwanted sagging when under load. Additionally, as many of the loads placed on the rigid support member may be centrally located, it may be desirable to include centrally-located support to assist in distributing the load over the rigid support member and the associated framework/frame elements. Therefore, the cargo-supporting framework may also include a lower supporting frame 22 positioned below the peripheral frame 20. The lower supporting frame 22 extends approximately between the center pair of supporting ribs 18 as shown in FIGS. 1 and 2, and may therefore be approximately rectangular in shape. In at least some embodiments, an uppermost portion of the lower supporting frame 22 is positioned immediately adjacent a lower edge of the peripheral frame 20, whereby the rigid support member is able to rest on portions of the lower supporting frame extending between the center pair of supporting ribs 18 of each of the side frame members 10.

The lower supporting frame 22 includes a pair of cross members extending across the cart. The cross members 24 may be simple pieces of plate steel disposed vertically for maximum vertical strength and attached to the central supporting ribs 18. Of course, the cross members 24 may be formed of any desirable shape (including angle steel) to achieve any desired strength and rigidity characteristics. In at least some embodiments, the lower supporting frame also includes a lower side member 26 extending approximately between the center supporting ribs 18 of a single side frame member 10 to add strength and rigidity to the cargo-supporting framework in that direction. The lower side member 26 may also be formed of plate steel disposed vertically and attached to the cross members 24.

As may be seen from FIGS. 1 and 2, the cargo-supporting framework assumes a stepped configuration with a central portion that extends downward lower than end portions on either side of the central portion. This configuration provides a natural alternative configuration by which a forklift or similar device can be used to lift the cart. The forks of the forklift are naturally guided to either side of the lower central portion and the forklift is able to lift the cart by lifting on upper portions of the cargo-supporting framework. As in many instances cargo being carried by the cart will be directly supported by the cargo-supporting framework through the rigid support member, the forklift almost directly supports the carried cargo.

The cargo-supporting framework is only one portion of the frame that extends between the side frame members 10. At each end of the side frame members 10, a frame bin 28 extends between and is attached to the side frame members 10. The frame bins 28 may be used for storage in addition to providing structural support. The frame bins 28 may be formed from bent sheet metal, plate steel, or the like, and may be permanently (e.g. welded) or reversibly attached to the side frame members 10.

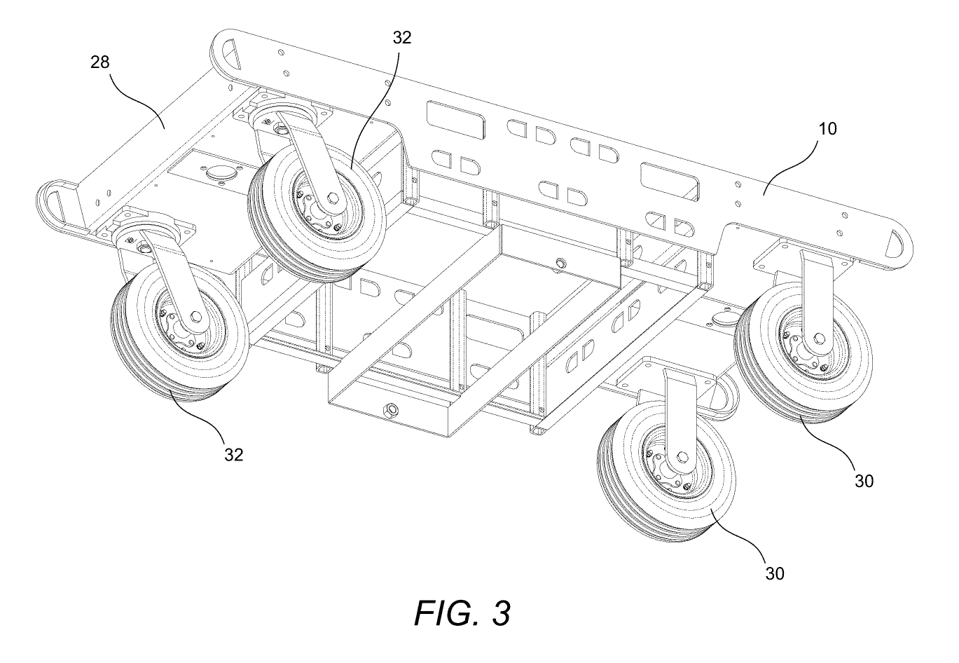

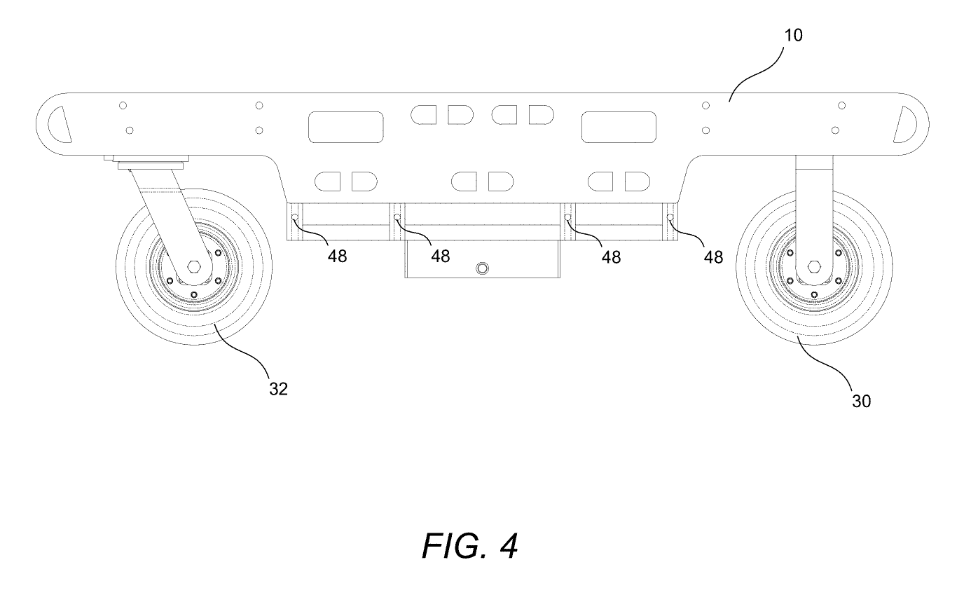

Using a forklift, a crane, or similar devices to transport the cart are merely examples of one way the cart can be used to transport cargo. To facilitate cargo transport across surfaces, the cart includes a pair of wheels 30 and a pair of casters 32, as shown in FIGS. 3 and 4. These Figures show perspective and side views of the frame shown in FIGS. 1 and 2, to which the wheels 30 and casters 32 have been added. The wheels 30 and casters 32 are attached to bottom surfaces of the frame bins 28, proximate the side frame members 10, where the weight of the cart passing to the wheels 30 and casters 32 is least likely to deform the frame bins 28. The combination of the wheels 30 and the casters 32 provides the cart with controlled maneuverability.

It should be understood that in some embodiments, the cart may be provided with two pairs of casters similar to casters 32 instead of one pair of wheels 30. Such an embodiment may be more maneuverable in certain situations, while in other situations, the pair of fixed-direction wheels 30 as shown in FIGS. 3 and 4 may provide more stability in movement of the cart. In some embodiments where casters 32 are present, one or more of casters 32 may be provided with a mechanism to selectively lock a direction of movement of the casters 32. While a total of four wheels 30/casters 32 are depicted in FIG. 1, some embodiments have more or fewer wheels 30/casters 32, such as two wheels 30 on one end of the cart and one caster 32 on the other end of the cart.

The wheels 30 and the casters 32 facilitate manual pushing and pulling of the cart over a variety of relatively-smooth to moderately bumpy or rough surfaces. Examples of such surfaces include catwalks, roads, paths, or any such surface where a cart is desirable. The combination of wheels 30 and casters 32 permits steering of the cart during translation/movement over a surface. Additionally, when the cart is towed as will be discussed below, the combination of wheels 30 and casters 32 facilitates towing of the cart.

The wheels 30 and the casters 32 may be manufactured to any suitable size and using any suitable material(s). In certain embodiments, it is envisioned that the cart may be used in environments where the cart will be exposed to certain chemicals, solvents, or other materials that can degrade certain commonly-used wheel materials. Therefore, the cart may be provided with wheels 30 and casters 32 manufactured from any of a variety of chemically-resistant materials suited to each particular application. Small wheels 30 and casters 32 may be used for embodiments to be used primarily or exclusively on hard and flat surfaces, but where it is envisioned that the cart may be used in more-rugged environments, the wheels 30 and casters 32 may be designed accordingly. Thus, for example, the wheels 30 and casters 32 may include eight- to twelve-inch pneumatic tires. Larger and smaller wheels 30 and casters 32 may be used according to the needs of the situation such as cart size and anticipated surfaces over which the cart will be moved. Larger wheels 30 and casters 32 such as these allow the cart to more-readily traverse uneven terrain, and even permit the cart to be towed by a variety of vehicles, as will be discussed in more detail below.

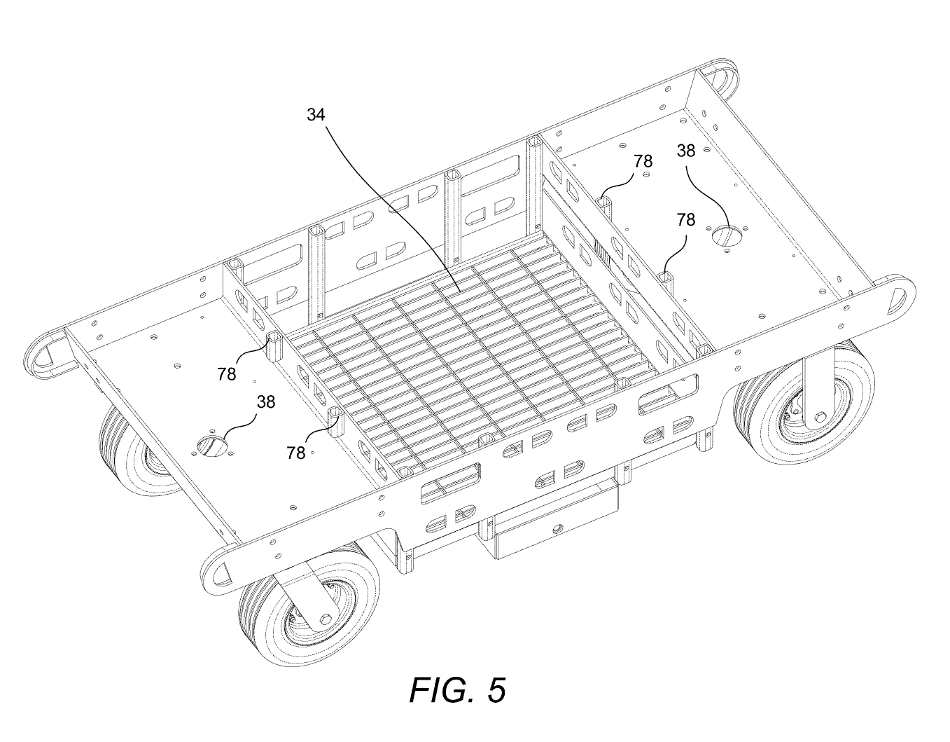

FIG. 5 shows a perspective view of the configuration shown in FIGS. 3 and 4, but with a rigid support member 34 or grating deck added thereto. The rigid support member 34 rests on and may optionally be attached to the peripheral frame 20. The rigid support member 34 is supported both by the peripheral frame 20 and by the lower supporting frame 22. The rigid support member 34 forms a cargo-supporting surface, spreading and distributing any load thereon, thus providing a cargo-supporting surface. It will be appreciated that the size of the cargo-supporting surface (and the cart itself) may be chosen from a wide variety of sizes according to the specific needs of use of the cart. The rigid support member 34 may be made of any of a variety of materials, including grating as shown in FIG. 5, expanded metal, plate steel, composites, wood, or a variety of other suitable materials now known or later invented. The rigid support member 34 may be configured to support any of a variety of weights, including, as an example only, one thousand five hundred pounds. The weight rating of the rigid support member 34 may vary depending on the size and intended use of the cart. For reasons that will become more apparent, some embodiments may have at least some holes, spaces, or other means for drainage through the rigid support member 34.

Various devices may be used to secure carried equipment or other cargo within the cart and on top of the rigid support member 34. For example, one or more straps (not shown) may be used to secure the cargo within the cargo-supporting framework. The straps may function well for large pieces of equipment or other cargo and/or for heavy/bulky cargo that is not too small in size, for example. The straps may be secured to any of the various openings as desired, including the large openings 12, the small openings 14, or openings in the rigid support member 34. Another possible securing device (not shown) is a cargo net, which may function well for smaller items and/or to secure sub-portions of certain cargo items, such as cables, tubing, and the like. When not in use to secure cargo, any securing devices may optionally be stowed in one or both of the frame bins 28.

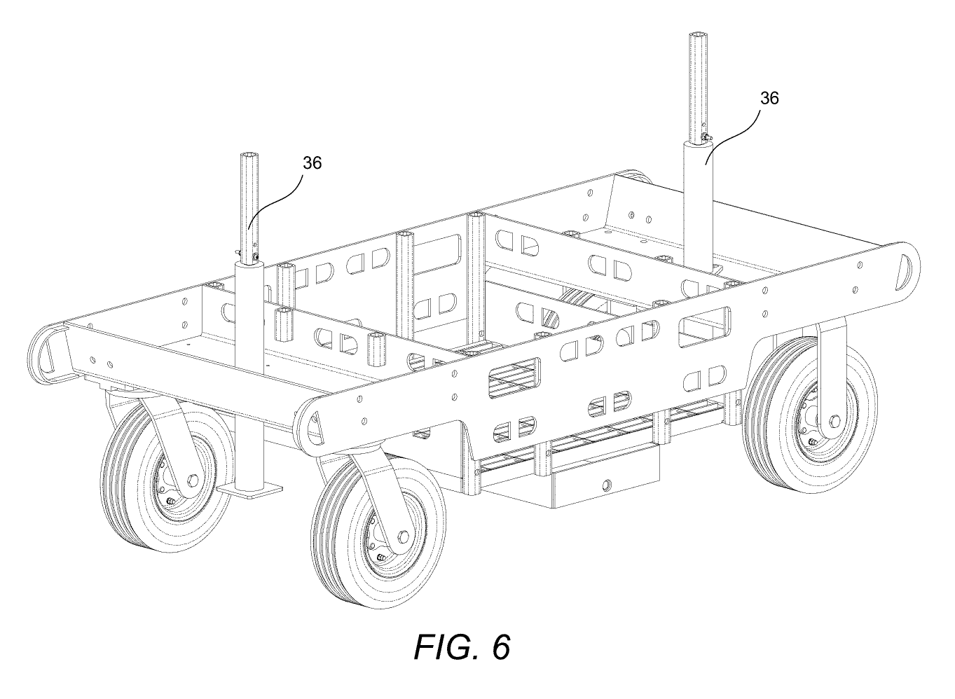

When it is desired that the cart be fixed in place for any reason, such as to permit loading or unloading of the cart, or to use the cart as a work platform in any of the manners discussed herein, a variety of features may be used to fix the cart in place. Any of the large openings 12, small openings 14, or end openings 16 may be used to connect one or more tie downs to an underlying surface, wall, or other fixed structure. Alternatively, one or more screw jacks 36 may be provided to the cart as shown in FIG. 6. FIG. 6 shows the configuration of FIG. 5 with the addition of two screw jacks 36, one screw jack 36 associated with each frame bin 28. The screw jacks may be mounted to each of the frame bins 28 through a screw jack mounting hole 38, as shown in FIGS. 2 and 5. The screw jacks 36 may be mounted at the mounting holes 38 using a rubber washer or a washer made of another compressible material to permit some adjustment and alignment of the screw jacks 36 with other features of the cart as will be understood from the later discussion below. As best shown in FIG. 2, the frame bins 28 may be reinforced at the location of the screw jack mounting hole 38.

Thus, one screw jack 36 is provided at each end of the cart. With other embodiments, a screw jack 36 may be provided proximate each wheel 30 and/or caster 32. As may be appreciated, the use of screw jacks 36 allows fixing the location of the cart in locations not readily amenable to the use of tie downs or may permit some degree of leveling of the cart. The use of the screw jacks 36 not only allows securing of the cart in a desired location, but may also assist in maintenance of the cart (e.g. changing a tire, etc.) One or more screw jacks 36 may be used as a braking device when the cart is used on a sloped surface, assisting to control and/or prevent descent down the surface. The screw jacks 36 may be of varying sizes depending on the number of screw jacks provided to the cart and the anticipated use of the cart.

It is anticipated that the cart may be useful in a variety of environments. One example of a particular type of environment where it is anticipated that the cart may be useful is in the oil and gas refining and processing industry. In such environments, it is common for certain parts or equipment used in, for example, the refining process to be removed and replaced periodically, after breakage/wear/damage, or on a regular basis, such as for routine maintenance. As may be appreciated, when the cart is used to transport such parts and equipment, such parts and equipment may contain or have various levels of saturation in a variety of oil products and other chemicals. It may be very desirable to capture any such products or chemicals that leak from the carried parts and equipment so as to prevent or reduce unwanted spills during transportation or storage of the parts and equipment in the cart.

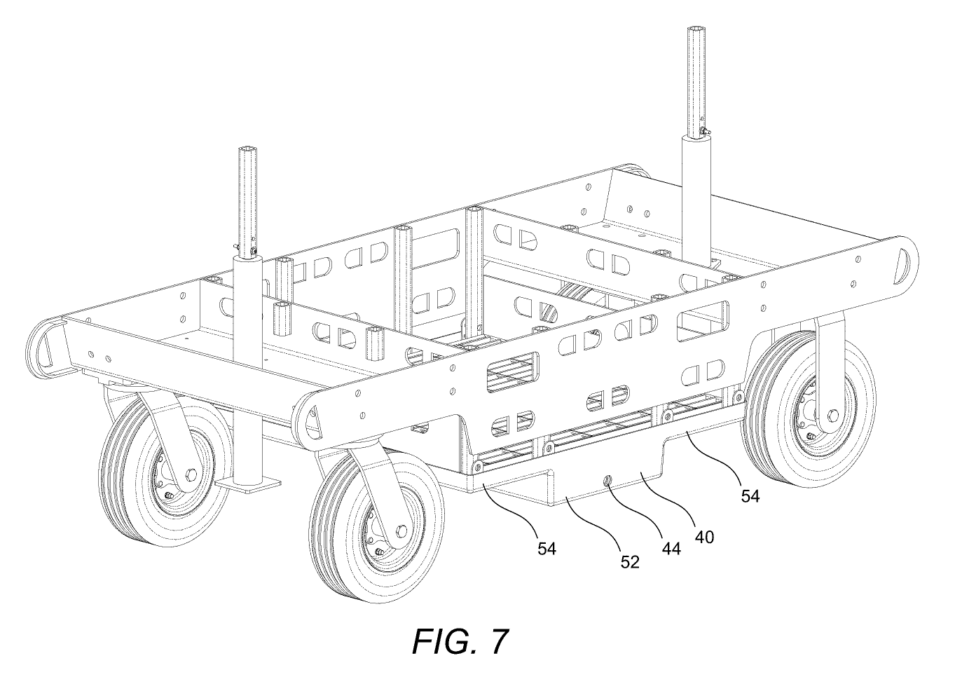

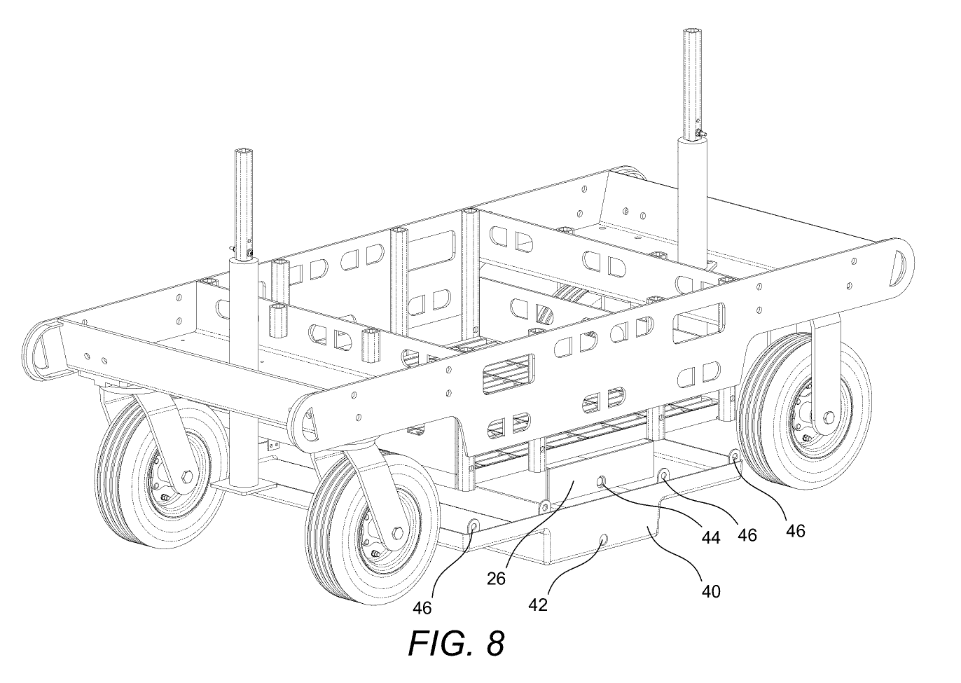

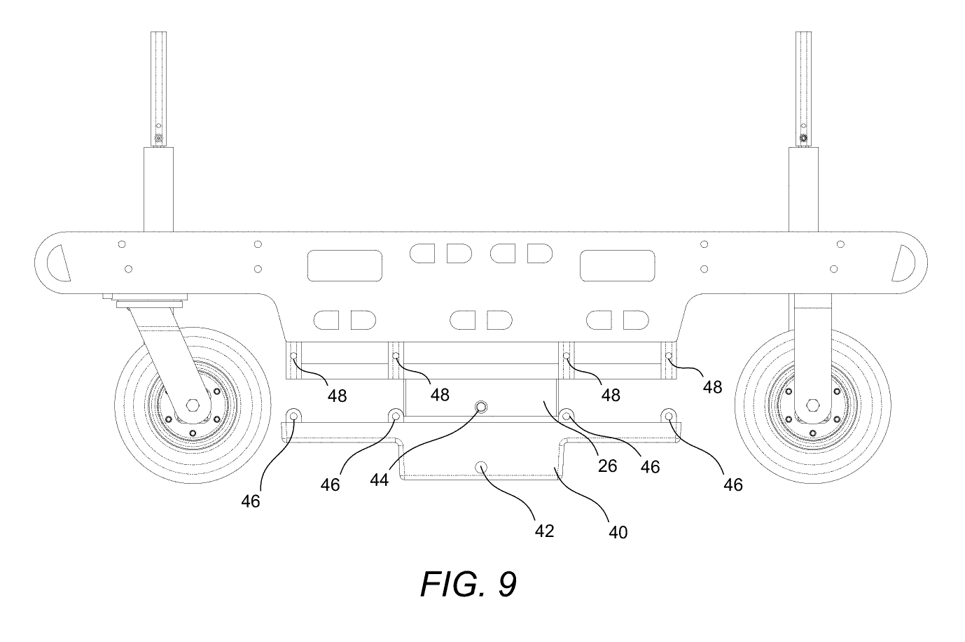

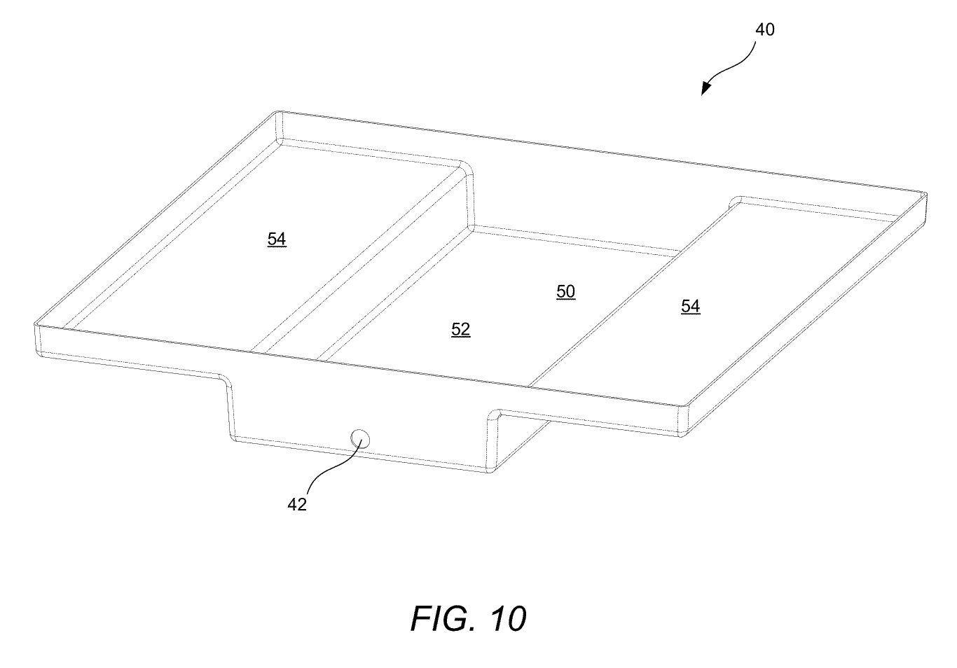

In environments where it is anticipated that the cart will be used to carry items that may have such chemicals or other materials, the rigid support member 34 may be made of or coated with a material resistant to such chemicals or other materials. Regardless of whether the rigid support member 34 is present or not, embodiments of the cart may optionally be provided with a containment pan 40 such as is illustrated in FIGS. 7-10. FIG. 7 shows the containment pan 40 in a position in which it would be attached to the cart, FIGS. 8 and 9 show the containment pan 40 detached from the cart and below the cart as if the containment pan were resting on an underlying surface, and FIG. 10 shows a perspective view of an alternate embodiment of the containment pan 40.

The containment pan 40 shown in FIGS. 7-9 is designed to fit under and at least partially enclose the supporting ribs 18, and to attach thereto. The containment pan 40 contains a drain port 42 to permit selective emptying of the containment pan 40 without necessarily requiring removal of the containment pan 40 from the cart, and the lower side member 26 has a corresponding drain opening 44. The drain port 42 can be sealed by, for example, a bolt, washers, and a nut that when tightened effectively seal the drain port 42, including by pressing the side wall of the containment pan 40 around the drain port 42 tightly against the lower side member 26 around the drain opening 44. Thus, when the containment pan 40 is to be drained, the cart may be selectively transported to a location where any material leaving the drain port 42 will be captured as desired or will drain into a desired location, and the drain port 42 may then be opened. Thus, a user of the cart need not go to the trouble of removing the containment pan 40 from the cart to drain any contents thereof.

However, as shown in FIGS. 8 and 9, the containment pan 40 can be removed from the cart on any reasonably-flat surface. The containment pan 40 is then dropped to the underlying surface and can be slid sideways out from under the cart, or the cart may be rolled away from the containment pan 40 after the containment pan is lowered to the underlying surface. Thus, the containment pan 40 can be removed and replaced as desired, such as for cleaning, using a separate containment pan 40 to prevent a possible mixture of chemicals or materials that should not be mixed in a single containment pan (e.g. due to transporting two different objects leaking the chemicals or materials), to permit continued use of the cart without the containment pan 40 while an object leaking materials to be contained is left in the containment pan 40 alone, etc.

As is shown in FIGS. 7-9, the containment pan 40 includes a plurality of pan attachment points 46. The pan attachment points 46 correspond to corresponding attachment points 48 on the supporting ribs 18. The corresponding attachment points 48 are best viewable in FIGS. 4 and 9. In the illustrated embodiment there are four pan attachment points 46 on each side of the containment pan 40, corresponding to the four supporting ribs 18 on each side of the cart. When the containment pan 40 is positioned underneath the supporting ribs 18 and lifted up to envelope at least a lower portion of the supporting ribs 18, typically with the lower portion of the supporting ribs 18 contacting a lower portion of the containment pan 40, the pan attachment points 46 line up with the corresponding attachment points 48 on the supporting ribs 18. The containment pan 40 is then attached to the cart such as by inserting a pin, bolt, screw, rivet or other securing device through the pan attachment points 46 to or through the corresponding attachment points 48. The attachment may be readily-reversible, semi-permanent, permanent, or with any desired relative permanence or ease of removal that comports with the spirit of the embodiments of the invention.

Thus, the illustrated pan attachment points 46 are merely one example of a means for attaching the containment pan 40 to the cart. Any other means for attaching the containment pan 40 to the cart may be used. Examples of such means for attaching the containment pan 40 to the cart include screws (e.g. sheet metal screws) or other attachment devices drilled through the sides of the containment pan 40 into the supporting ribs 18, spot welding the containment pan 40 to the supporting ribs 18, bonding the containment pan 40 to the supporting ribs 18, clipping the containment pan 40 to the supporting ribs 18, or any other attachment means now known or later invented. Thus, an embodiment of the containment pan 40 shown in FIG. 10 not having distinct pan attachment points 46 can readily be attached to the cart.

The embodiments of the containment pan 40 shown in FIGS. 7-10 have a stepped bottom 50 having a lower central portion 52 flanked by higher side portions 54. The higher side portions 54 are disposed to receive forks of a forklift placed thereunder to permit lifting of the cart by the forklift as discussed above with respect to a configuration without the containment pan 40 attached. When the containment pan 40 is attached, it may serve to more-evenly distribute lifting forces of the forklift to the cargo-supporting framework. This stepped configuration also may assist in centering the forks of the forklift on the cart.

As the stepped configuration of the containment pan 40 corresponds to the stepped configuration of the cargo-supporting framework, it will be appreciated that when the containment pan 40 is attached to the cargo-supporting framework (as shown in FIG. 7, for example), upward forces applied to the containment pan 40 (e.g. by a forklift at the higher side portions 54) will be transferred to the cargo-supporting framework and thence to the cart frame, the rigid support member 34, and any supported load. The load-transfer features of the containment pan 40 are therefore similar to those discussed previously, and permit forklift carrying of the cart even when loads on the cart prevent using the large openings 12 to receive the forks of the forklift.

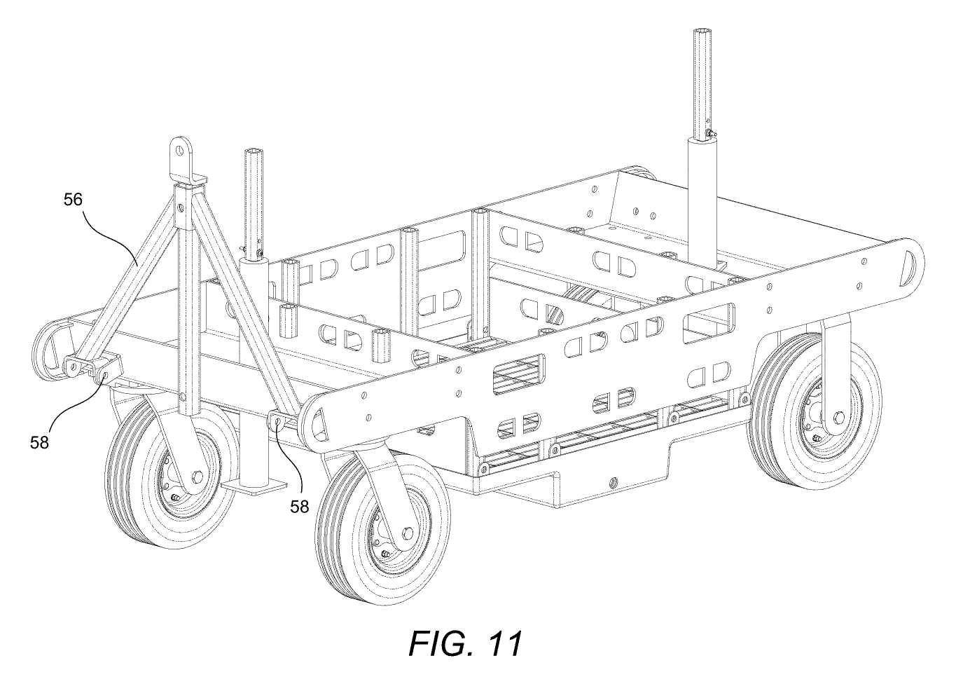

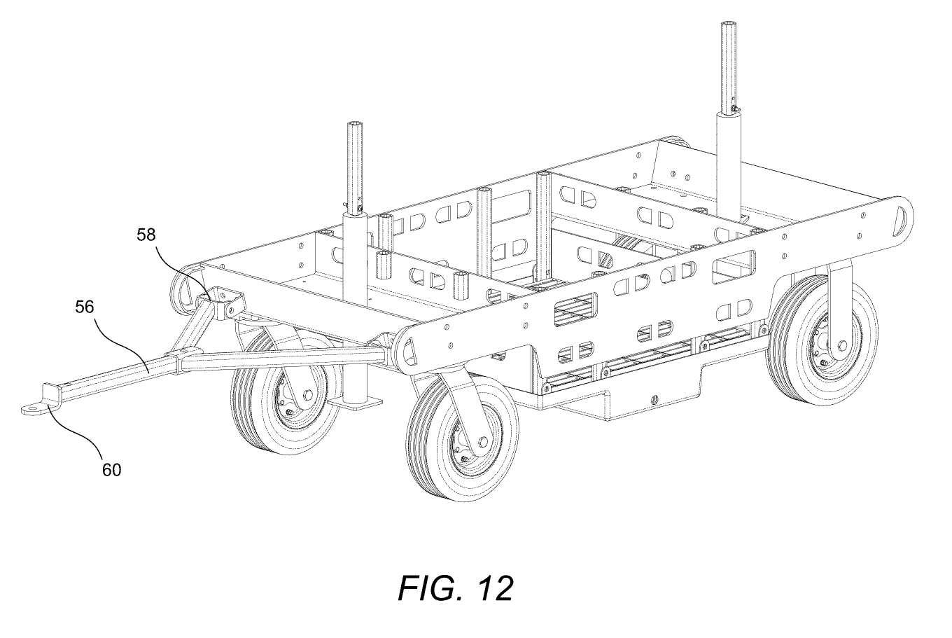

As discussed above, the cart is useful for transporting items over relatively-short distances on relatively-flat to moderately-rough terrain. In addition, the cart may include features allowing transport of cargo over great vertical distances such as by crane or forklift, as discussed above. Furthermore, FIGS. 11 and 12 show a trailer hitch 56 that allows the cart to be used to transport cargo over relatively-long distances on relatively-flat to moderately-rough horizontal terrain. As shown in FIGS. 11 and 12, the trailer hitch 56 may be extendible, foldable and/or reversibly detachable from the cart. The trailer hitch 56 may be extendible so as to extend farther from the cart when deployed, as will be discussed in more detail later. In FIG. 11, the trailer hitch 56 is attached to one of the frame bins 28 at a hinge 58. This allows the trailer hitch 56 to fold up as shown in FIG. 11 and to rest adjacent and be connected to a handle portion of the cart (as will be discussed shortly), where it is out of the way when the cart is being pushed or pulled and not towed using the trailer hitch 56. The hinge 58 may be or include a pinned connection, whereby if the pins are removed the trailer hitch 56 may be readily removed from the cart.

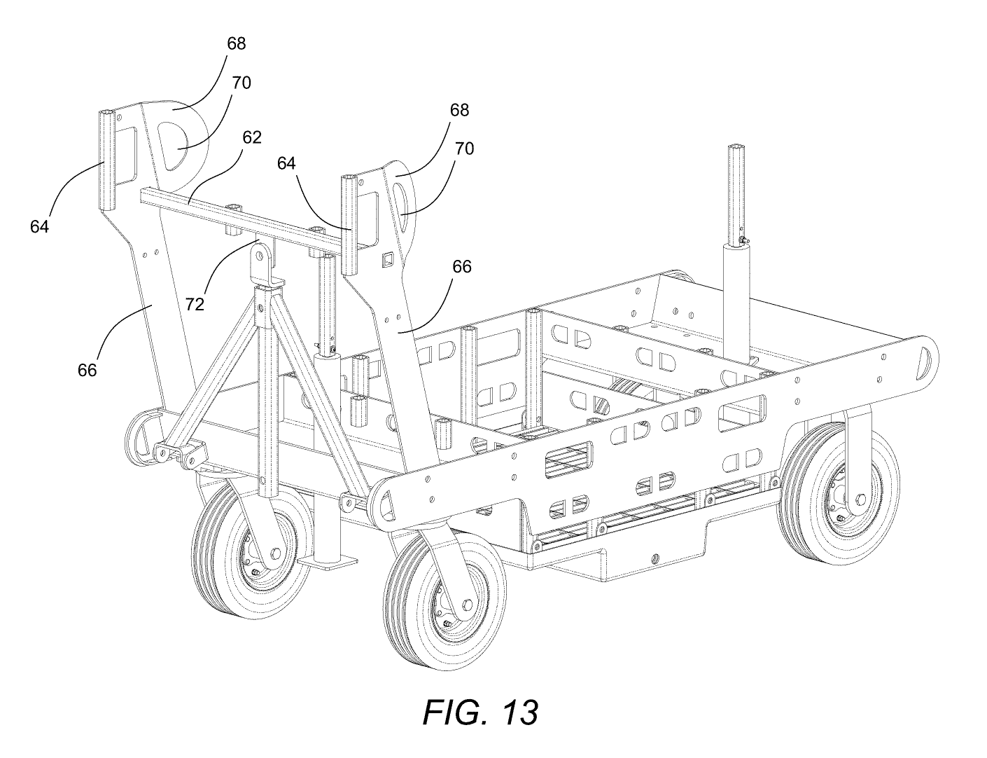

When the trailer hitch 56 is to be used to tow the cart, the trailer hitch 56 is attached and/or folded down as shown in FIG. 12, and a tongue 60 can be extended to increase the extension of the trailer hitch 56 from the cart. The relatively large wheels 30 and casters 32 of the cart, which may be pneumatic, permit towing of the cart for relatively long distances with the trailer hitch 56. When towing is complete, the tongue 60 is retracted and the trailer hitch 56 is folded back up and stowed so as to be out of the way for pushing or pulling the cart. FIG. 13 illustrates one way in which the trailer hitch can be stowed, e.g. by attaching it to an element connected to a handle portion of the cart.

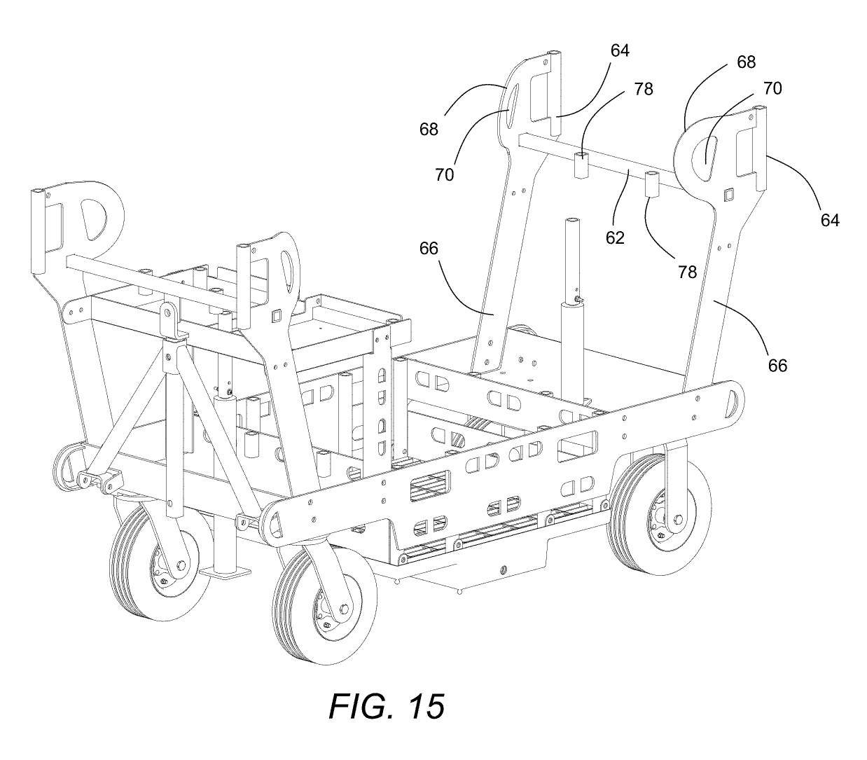

FIG. 13 depicts a configuration of the cart similar to the configuration of FIG. 12, but with a first handle portion attached thereto. The first handle portion shown in FIG. 13 includes two types of handles disposed at an ergonomic height for convenient pushing or pulling of the cart. The first type of handle is a horizontal handle 62 that may be sized so that two persons may readily use the horizontal handle 62 to push or pull the cart. As will be appreciated from the further discussion below, when both first and second handle portions are present (as illustrated and discussed below with respect to FIG. 15, four (or more, if necessary) people may push and/or pull the cart. For illustration purposes only, the horizontal handle may be disposed at an ergonomic height suitable for most users, such as a height of approximately forty-one inches above the surface underlying the cart.

In addition to the horizontal handle 62, the first handle portion includes a pair of vertical handles 64 that are disposed at an ergonomic height suitable for use of this type of handle, such as a height of approximately forty-five inches above the surface underlying the cart. For reasons that will become apparent later, both the horizontal handle 62 and the vertical handles 64 are formed from square tubular material, and both ends of the horizontal handle 62 and at least upper ends of the vertical handles 64 are open ends capable of receiving objects. The horizontal handle 62 and the vertical handles 64 are attached to handle frame elements 66 that extend from within the frame bin 28 of that end of the cart. The handle frame elements 66, while terminating within the frame bin 28, may be attached not only to the frame bin 28 but to the side frame members 10 as well.

The handle frame elements 66 may be made from a variety of materials, such as plate steel, and have significant strength. An upper portion of each of the handle frame elements 66 includes an inwardly-angled portion 68 that has a crane attachment point 70 formed therein. The crane attachment point 70 serves (in conjunction with a similar feature on a second handle portion as discussed below) to provide an alternative attachment point for hoisting the cart such as by a crane. The crane attachment points 70 ensure that the hoisted cart has a low center of gravity compared with hoisting using, for example, the end openings 16, and also minimizes the possibility that tension on the cables used for hoisting will damage any items within the cart, as the crane attachment points 70 are commonly well above any cargo stored in the cart. As may be seen in FIG. 13, the horizontal handle 62 has a hitch attachment point 72 attached thereto, and when the trailer hitch 56 is to be stowed, it can be secured to the hitch attachment point 72.

The cart may be provided with a wide variety of equipment storage options suitable for the desired use and application of the cart, as will be appreciated and discussed further herein. For example, the frame bins 28 located at each end of the cart have previously been mentioned. The frame bins 28 may be used for storing a wide variety of items, such as rigging, tie downs, and straps when not in use, as well as a variety of other items. As the frame bins 28 are located at the ends of the cart, they are typically readily accessible to persons pushing or pulling the cart.

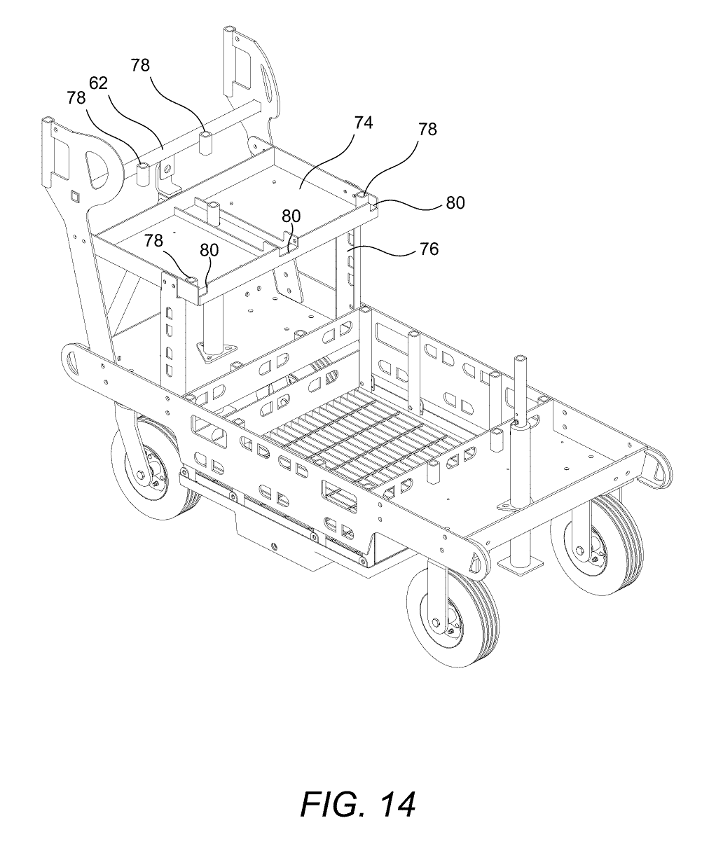

While the frame bins 28 provide some capability to store and/or transport items with the cart, the cart includes features permitting it to carry items much larger than could be stored in the frame bins 28 alone, which features have been discussed at least in part above. A first aspect of such features is the cargo-supporting framework. While in some instances, the cargo-supporting framework may electively support carried equipment or other cargo directly, the rigid support member 34 facilitates carrying heavy as well as bulky cargo. Even with these two storage options, additional storage options may be provided as illustrated in FIG. 14.

FIG. 14 shows a handle tray 74 that may be incorporated into certain embodiments of the cart. The handle tray 74 shown in FIG. 14 is attached to the first handle portion at the handle frame elements 66. The handle tray 74 is also supported by some tray supports 76 attached to the frame bin 28 (and to the side frame members 10). The handle tray 74 may permit convenient storage of frequently-accessed items or of items where it is desirable to provide rapid access. Examples of such items include hand tools, radios, clipboards, drawings, work instructions, and the like. While FIG. 14 shows a handle tray 74 attached proximate the first handle portion only, it should be appreciated that handle trays 74 may be attached proximate both handle portions when present.

The handle tray 74 includes receivers 78 that are adapted to receive modular elements and structures as will be discussed later. The receivers 78 are tubular elements having open top ends similar to the open top ends of the vertical handles 64 and the open ends of the horizontal handle 62. Similar receivers 78 may optionally be provided attached to the horizontal handle 62 as well, as shown in FIG. 14. It should be understood that the receivers 78 may be located at any desirable location on the cart and cart frame, and that different sizes of the receivers 78 may be provided according to the anticipated weight capacity needs of each receiver 78. Therefore, the specific sizes and locations of the receivers 78 illustrated in the Figures is intended to be illustrative, and not restrictive. The handle tray 74 includes receiving slots 80 that are used to receive an extended table top as will be discussed later.

FIG. 15 shows a configuration of the cart similar to that of FIG. 14, with a second handle portion attached thereto. The second handle portion is essentially identical to the first handle portion discussed with respect to FIG. 13, with two minor differences. First, it is attached to an opposite end of the cart. Second, as there is no trailer hitch 56 attached on this end of the cart, there is no need to have a hitch attachment point 72 on the horizontal handle 62. Although there is no need to have a hitch attachment point 72 on the second handle portion, it may simply be easier to manufacture the two handle portions to be identical, and the second handle portion may therefore optionally have an (unused) hitch attachment point 72, as depicted in other Figures.

In some instances, it may be desirable to permit two or more carts to be hitched or otherwise connected together so as to be transportable together. One way that this may be accomplished is using the trailer hitch 56 of one cart to connect to another cart to form a chain of two or more carts, and the chain could be towed in a fashion similar to that discussed above for a single cart. This might be useful, for example, if one cart contains welding equipment and is essentially full, and another cart contains parts or materials to be welded at a location on a worksite: rather than make two trips to move both carts to the desired location, the carts could be connected and moved together. To facilitate a connection between carts, a hitch receiver (not shown) could be mounted to an end of the cart (e.g. near a center of the frame bin 28 of the second handle portion). The hitch receiver could be relatively small and would likely not cause problems when the second handle portion is being used to push or pull the cart, as the second handle portion extends away from the cart body.

While FIG. 15 shows a configuration of the cart having first and second handle portions, it should be understood that the cart can be used in various configurations with no attached handle portions, with only a single attached handle portion, or with two attached handle portions. If only a single attached handle portion is present, it may be present at either end of the cart. If the cart is to be used exclusively for towing for an extended period of time, it may make sense to remove or not attach either handle portion, as there will be no need to push or pull the cart during that period of time. Such a configuration may make it easier to store larger items on the cart for towing. This is only one example of a rationale behind a choice to use the cart in a certain configuration. Various other factors may be used to determine whether to use a configuration with no handle portions, one handle portion, or two handle portions, and all such configurations are embraced by embodiments of the invention.

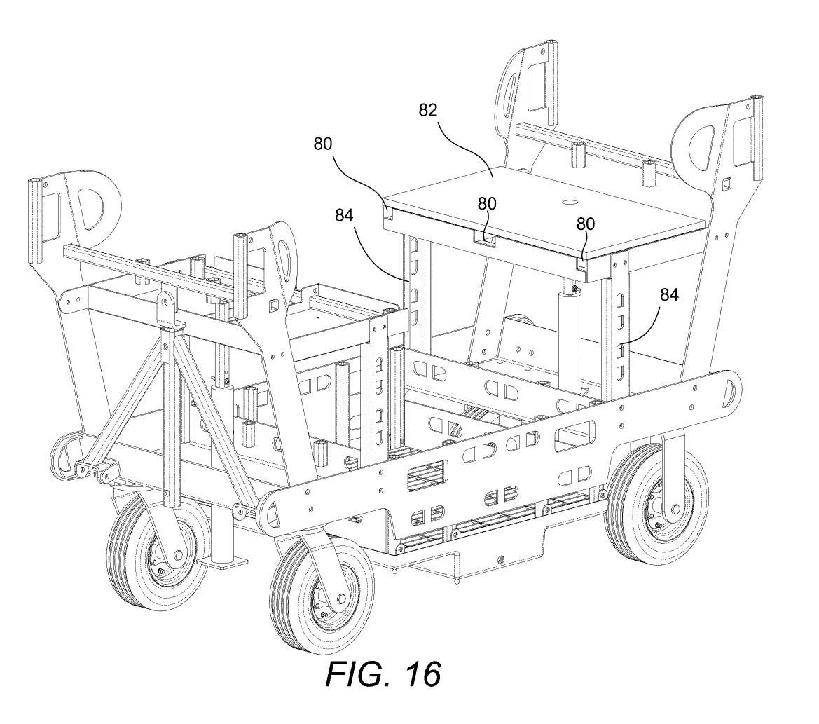

As may be expected, a handle tray 74 similar to that shown in FIG. 14 could be attached to the second handle portion shown in FIG. 15. Alternatively, a small workbench 82 may be attached proximate one of or both handles portions, as illustrated in the perspective view of FIG. 16. Attachment of the small workbench 82 to the cart may be similar or identical to attachment of the handle tray 74 discussed previously. In the illustrated embodiment, workbench supports 84 extend from an end of the small workbench 82 distal the associated handles down to the associated frame bin 28 and are attached to the respective frame bin 28/side frame members 10 to provide additional support to the small workbench 82. The small workbench 82 provides a working surface that may be useful on a job site for any of a variety of reasons, including working on items contained within the cart as well as items not contained within the cart. The small workbench 82 may optionally be provided with mounting holes for mounting a variety of desired work equipment items, such as vises and the like.

A frame portion of the small workbench 82 may be essentially identical to a frame portion of the handle tray 74. Additionally, the work surface of the small workbench 82 may be essentially identical to a bottom surface of the handle tray 74. Thus, in at least some embodiments, the handle tray 74 may be converted into the small workbench 82 simply by removing the bottom of the handle tray 74 and reattaching it on top of the handle tray's frame 74. Conversion of the small workbench 82 to the handle tray 74 is simply the reverse process. A hole in the work surface/tray bottom provides pass-through access for actuating the screw jacks as will be discussed briefly shortly. As the frames of the handle tray 74 and the small workbench 82 may be essentially identical, FIG. 16 shows that the small workbench 82 also includes the receiving slots 80.

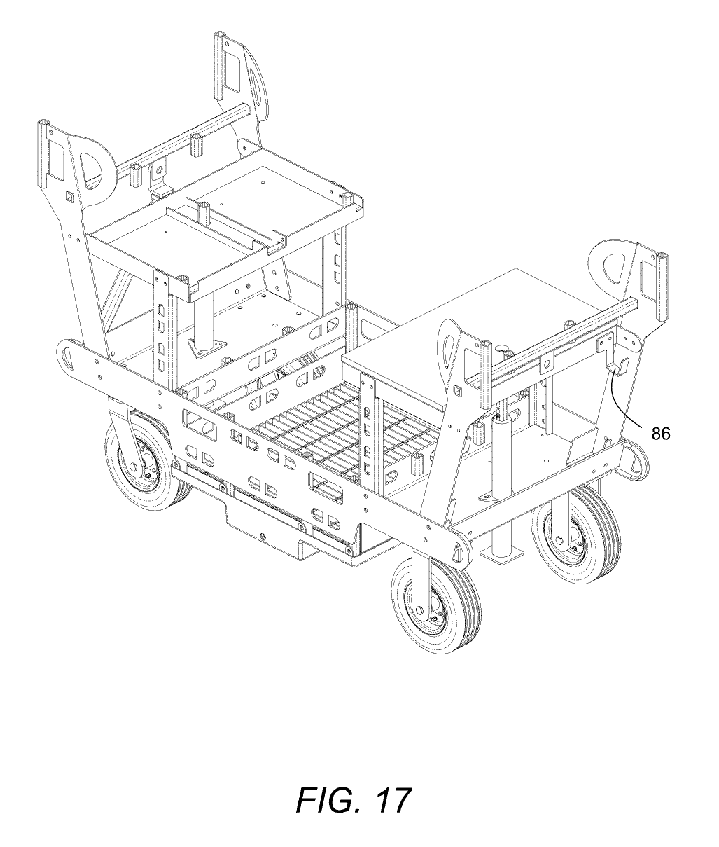

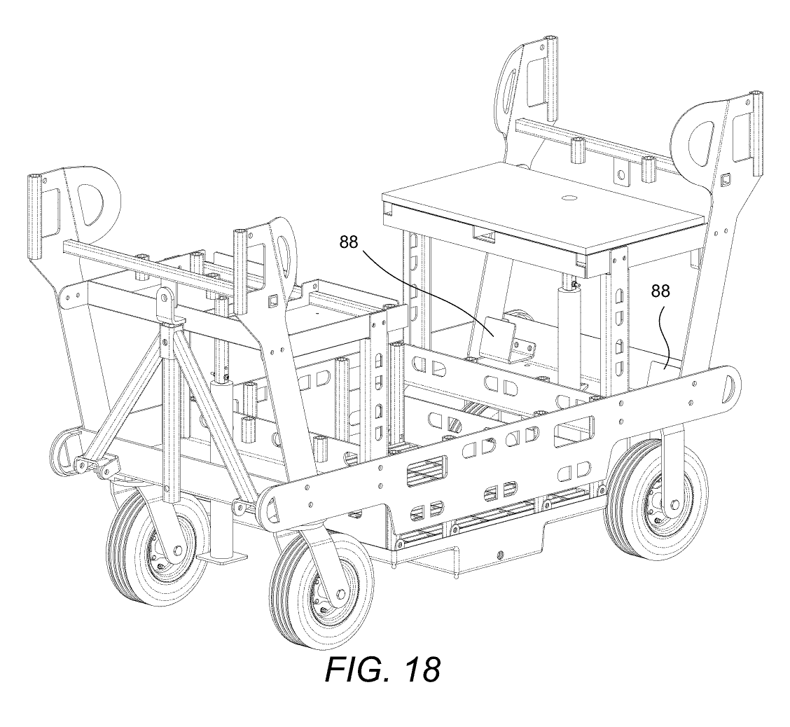

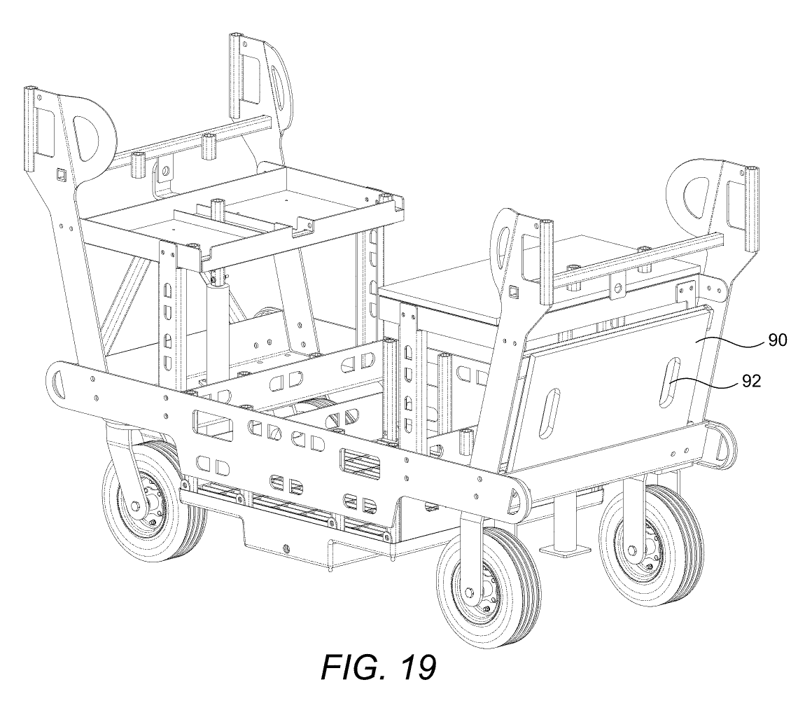

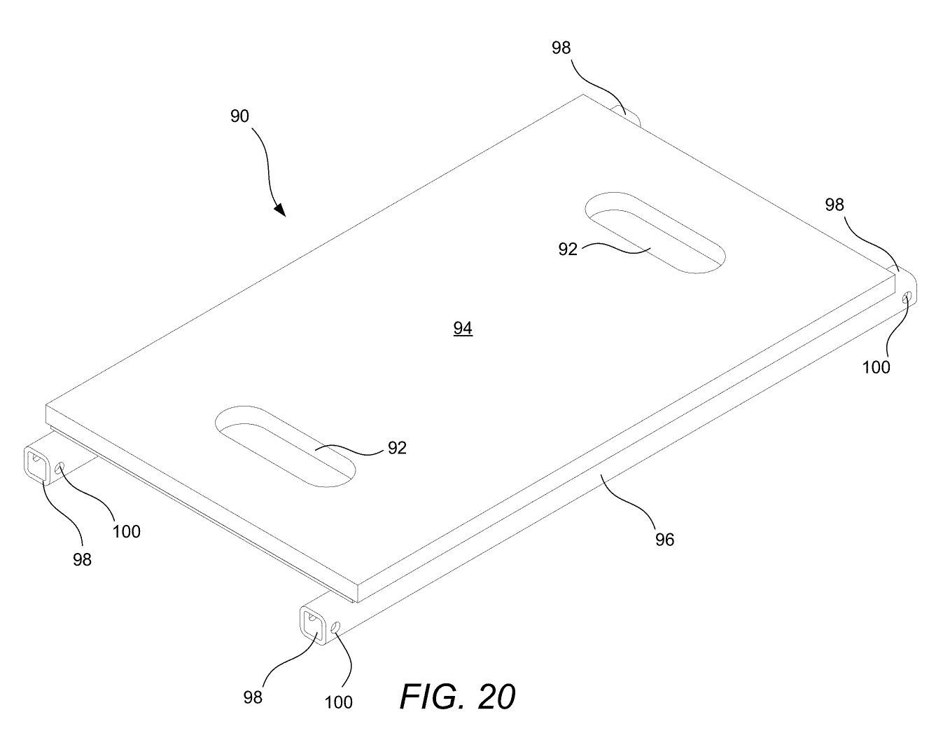

The receiving slots 80 of the small workbench 82 and the handle tray 74 are adapted to receive table sections to form a large workbench. FIGS. 17 and 18 show features that may be incorporated into the second handle portion to permit storage of the table sections when the table sections are not being used. FIG. 17 shows a perspective view of the cart where an upper storage bracket 86 is visible (another upper storage bracket 86 is symmetrically located adjacent the other handle frame element 66 of the second handle portion). FIG. 18 shows a perspective view of the cart where a lower storage bracket 88 is visible on each side of the frame bin 28. FIG. 19 shows two table sections 90 stored in the second handle portion using the upper storage brackets 86 and the lower storage brackets 88, while FIG. 20 shows a perspective view of a single table section 90.

As may be seen in FIG. 20, the table section 90 includes a pair of table handles 92 to facilitate handling of the table section 90. In the illustrated embodiment, the table handles 92 are cut into a piece of material forming a table surface 94. The material forming the table surface 94 is attached to a pair of table mounting tubular members 96 which protrude past the ends of the table surface 94 as four table section tabs 98. Each of the table section tabs 98 have a table mounting hole 100 passing therethrough whereby a pin or other securing means can be passed through the table mounting holes 100.

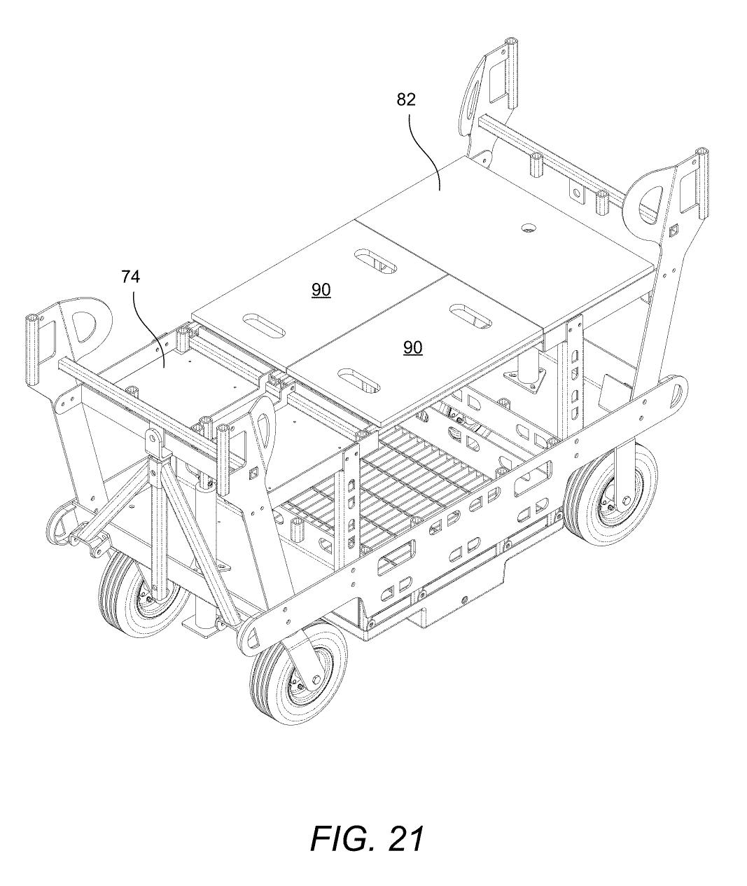

The table section tabs 98 rest in and interact with the upper storage brackets 86 and the lower storage brackets 88 so that two table sections 90 can readily be stored as shown in FIG. 19. The two table sections 90 are entirely stowed between the second handle portion's handle frame elements 66 and are not in the way of using the cart. When the large workbench is desired, the table sections 90 are removed from storage and the table section tabs 98 of one end of one table section 90 are inserted into the receiving slots 80 of the small workbench 82. The table section tabs 98 of the other end of the table section 90 are then dropped into the receiving slots 80 of the handle tray 74 and the process is repeated with the other table section 90 to form the configuration shown in FIG. 21.

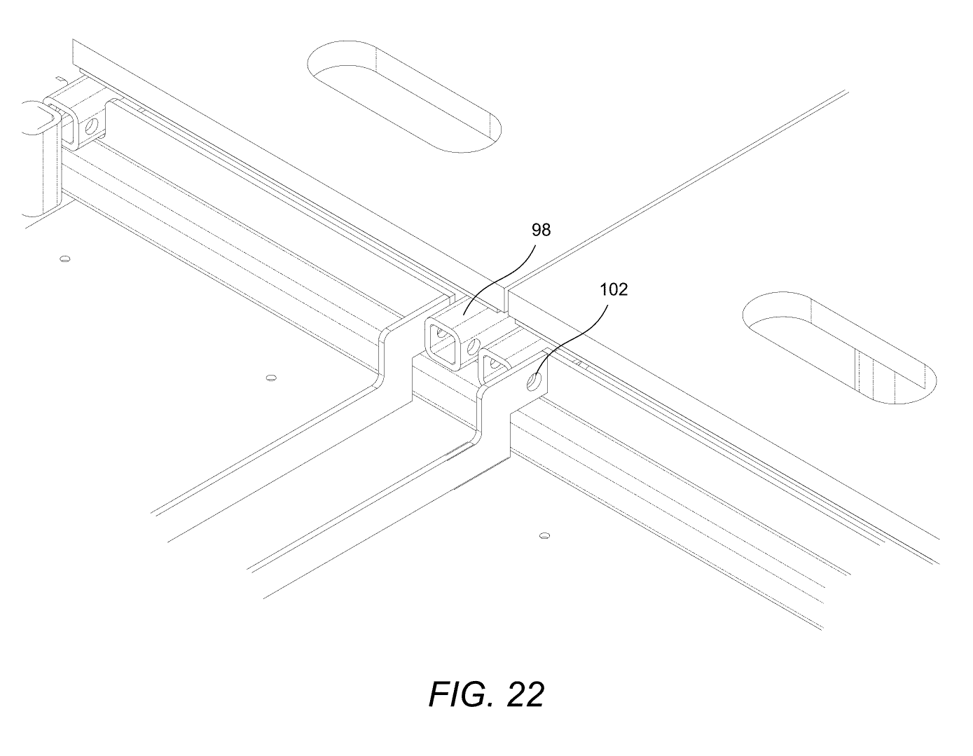

The work surface of the small workbench 82 retains the table section tabs 98 on that end of the table sections 90 and prevents them from falling out. At the other end of the table sections 90, as shown in detail in FIG. 22, a pin or bolt passes through a securing hole 102 in the center of the frame of the handle tray 74 and through the table mounting holes 100 of the table section tabs 98, thereby securing the table sections 90 against upward or lateral movement that could otherwise result in the table section tabs 98 falling out of the slots 80 of the small workbench 82. The large workbench configuration shown in FIG. 21 is thus secured such that the cart can be readily towed in this configuration with no concern that the table sections 90 will come loose or fall out.

A variety of materials may be used to provide the work surfaces of the small workbench 82 and the table sections 90, and the bottom surface of the handle tray 74. However, as wood is renewable and has a variety of advantageous features, such surfaces may be wood. Wood surfaces are forgiving to protect equipment and workers. Of course, as these surfaces wear, they can be replaced as needed. When these features are present, the handle tray 74 and various work surfaces may be located at an ergonomic height, such as thirty-seven inches.

The large workbench illustrated in FIG. 21 is only attached to and supported by the small workbench 82 and the handle tray 74. Therefore, access to items stored on and supported by the cargo-supporting framework may still be achieved even with the table sections 90 in place as shown in FIG. 21. Alternatively, one of the table sections 90 may be temporarily removed to improve access. The table sections 90 are essentially an extension of the small workbench 82, and the table sections 90 can be used singly or together. The size of the small workbench 82 and any table sections 90 will of course vary with the size of the cart. In many embodiments, the size of the full large workbench may exceed the size of the rigid support member 34, as it is not constrained to fit within the cargo-supporting framework. As with the small workbench 82, the table sections 90 may include attachment options for fixing a vise, pipe vise, or other equipment to the table sections 90.

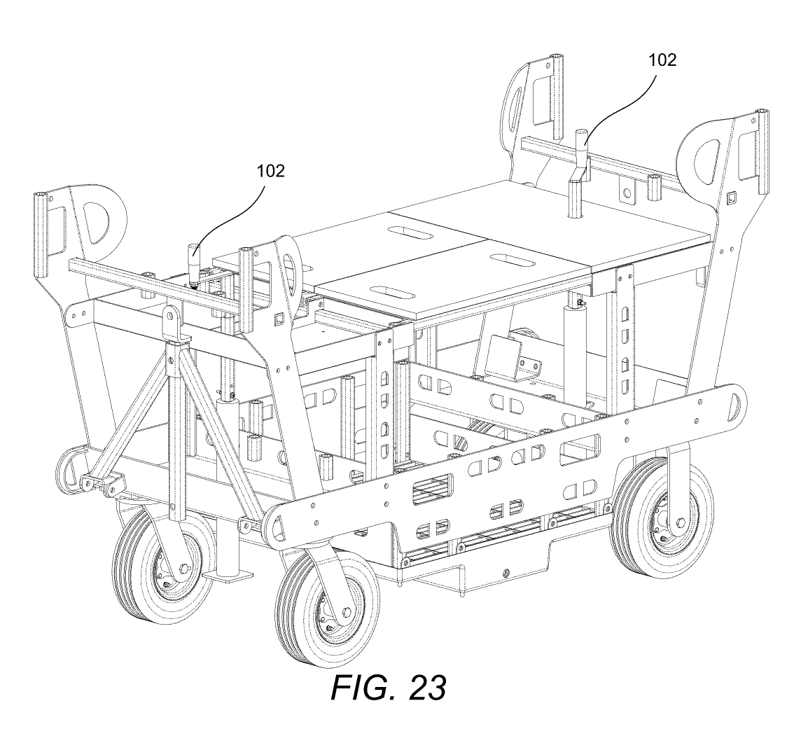

The screw jacks 36 were previously described with respect to FIG. 6. To enable pass-through access to the screw jacks 36, a hole is provided in each of the small workbench 82 and the handle tray 74. These holes may be used to engage a jack crank 104 with each of the screw jacks 36 in the fashion illustrated in FIG. 23. When the jack cranks 104 are not being used, they may be stored in the frame bins 28 or in the handle tray 74, or a clip or bracket may be provided in any of a variety of locations to secure the jack cranks 104. When the jack cranks 104 are being used as shown in FIG. 23, they permit turning the screw jacks 36 to achieve the function and purposes of the screw jacks 36 as discussed above.

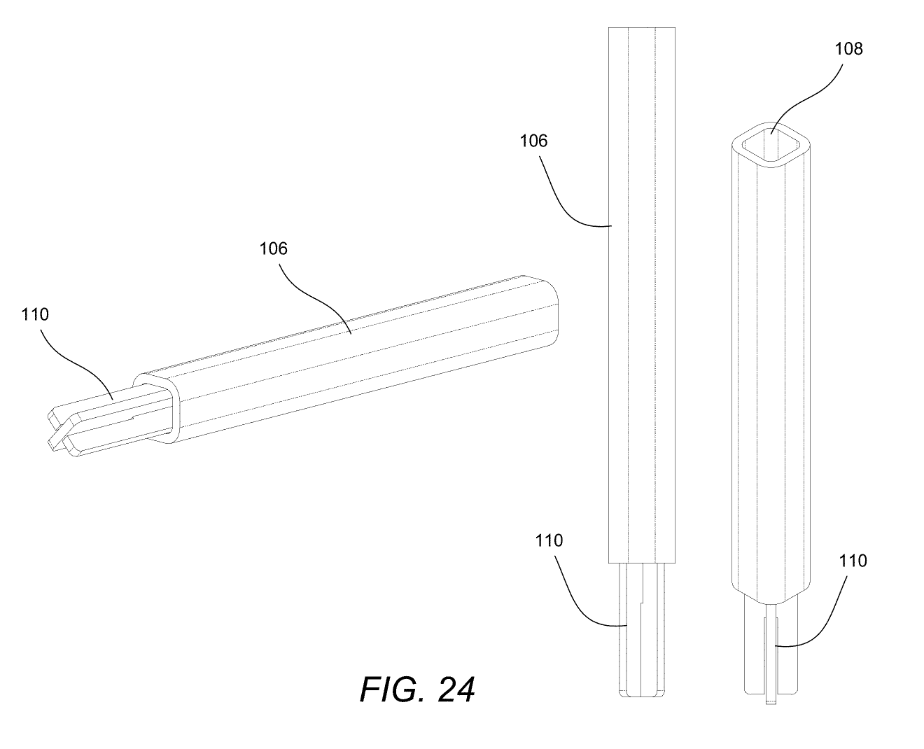

Mention has been made of various tubular structures having open ends and various receivers 78. In fact, as may be seen by reference to FIG. 1, each of the supporting ribs 18 has an open top, and FIG. 5 shows the presence of several receivers 78 within the frame bins 28. The receivers 78 may be placed essentially anywhere on and within the cart, and are adapted to receive various modular elements and structures. FIG. 24 shows various views of one of the most-basic modular elements used with embodiments of the invention, a modular post 106. The modular post 106 includes a tubular member forming an elongate body having an open end 108 (or a receiver end) and an insert member 110 configured to be received into the open end 108 or receiver end, as well as into any receivers 78 of the cart. Thus, the modular post 106 can be inserted into any receiver 78 of the cart and can receive additional modular posts 106 inserted into it.

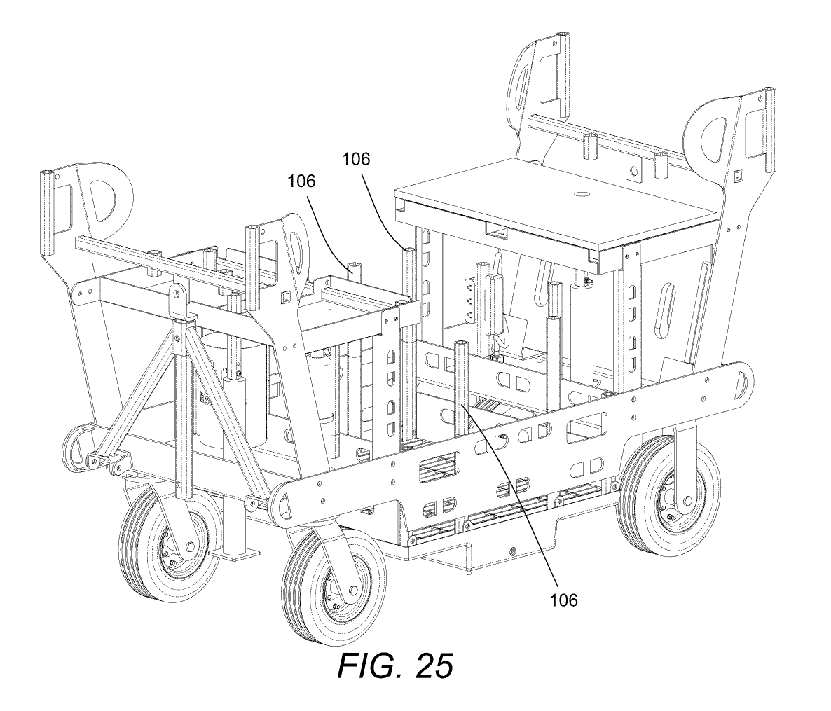

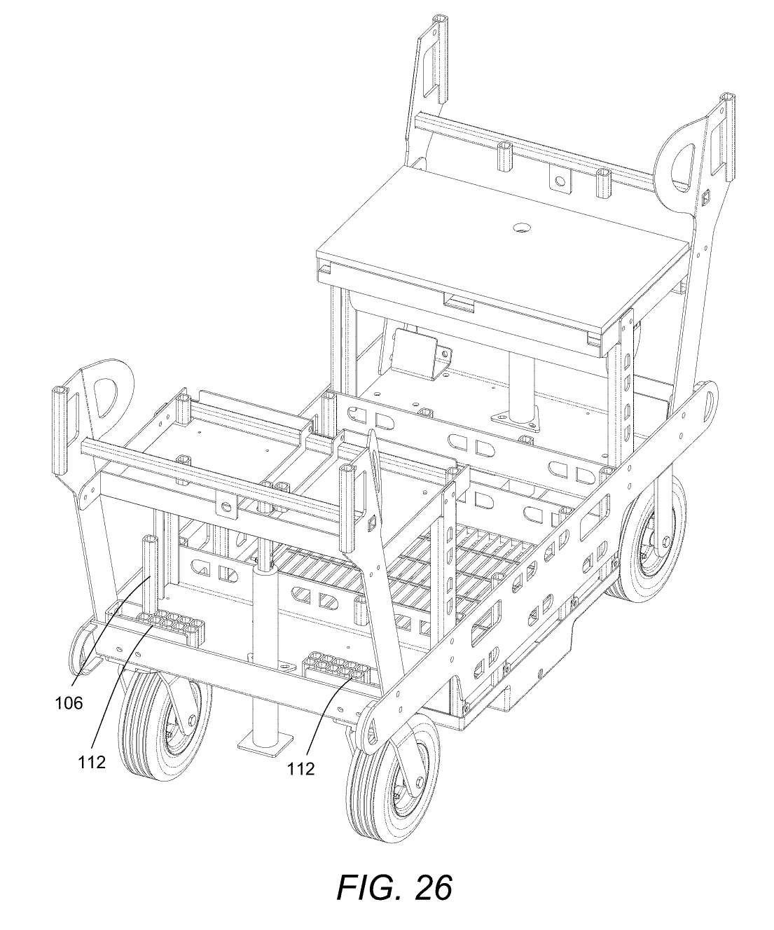

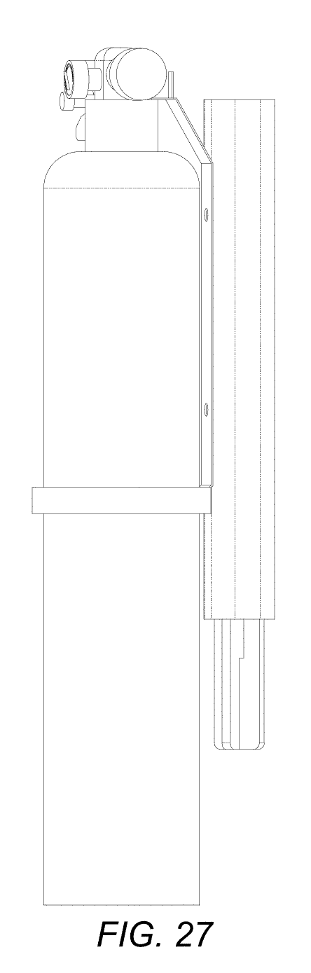

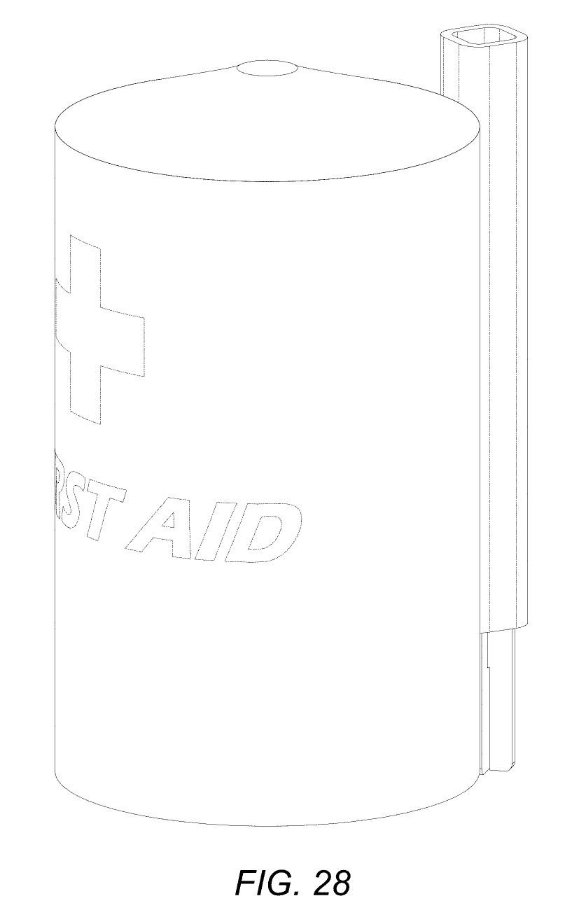

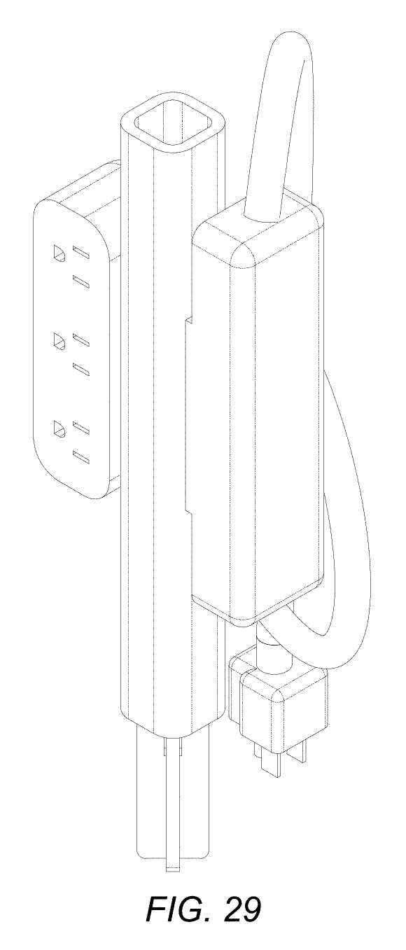

The modular post structure allows for a variety of specialized functions. For example, as illustrated in FIG. 25, the modular posts 106 may be attached to (e.g. inserted into) the supporting ribs 18. The modular posts 106 may facilitate carrying certain items within the cart, such as bulky items. Non-limiting examples of items that may be more-easily carried in bulk when using the modular posts 106 include hoses, insulation, cables and other wires, tubing, bagged items and material, and the like. When the modular posts 106 are not being used, they may be stored in a variety of locations on and off the cart, such as within one of the frame bins 28, within the cargo-supporting framework, or on a modular post rack 112 for the modular posts 106 attached to some point of the cart, such as is illustrated in FIG. 26. If additional height of the modular posts 106 is needed to ensure containment of carried cargo, additional modular posts 106 may be stacked until the needed height is reached. The modular posts 106 are sized such that they may be removed (e.g. by upward withdrawal from the corresponding supporting ribs 18) or inserted even with the table sections 90 in place. The modular posts 106 are merely a most-basic form of post that may be used with embodiments of the invention. A variety of specialty and dedicated posts may also be provided. Dedicated posts are posts that have been modified or have had additional items attached thereto to provide a specific dedicated function. For example, FIG. 27 shows a dedicated post that is dedicated to a fire extinguisher. FIG. 28 shows a dedicated post that is dedicated to an attached first aid kit. FIG. 29 shows a dedicated post that is dedicated to an attached power outlet distribution (which may be a GFCI multi-plug outlet). Other dedicated posts that are not specifically shown in the Figures include a dedicated post dedicated to an attached work light and dedicated posts dedicated to any other item that can be attached to a standard post.

Some or all of the various dedicated posts may be stored within the receivers 78 in the frame bins 28 when the cart is being used for transport purposes, but may readily be moved to different locations as desired. For example, when the cart arrives at a location where work is to be done and electrical power distribution is needed, the dedicated post of FIG. 29 may be removed from the receiver 78 in the frame bin 28 and may instead be inserted into the receiver 78 of the handle tray 74 or in one of the vertical handles 64 where it can be more-readily accessed. Similarly, if the work is potentially dangerous, the dedicated post of FIG. 28 may be similarly placed to make the first aid kit more accessible. If light is needed to complete the work, a worklight dedicated post may be moved into a desired position, including on top of several other dedicated or standard posts or stacked posts to elevate the light.

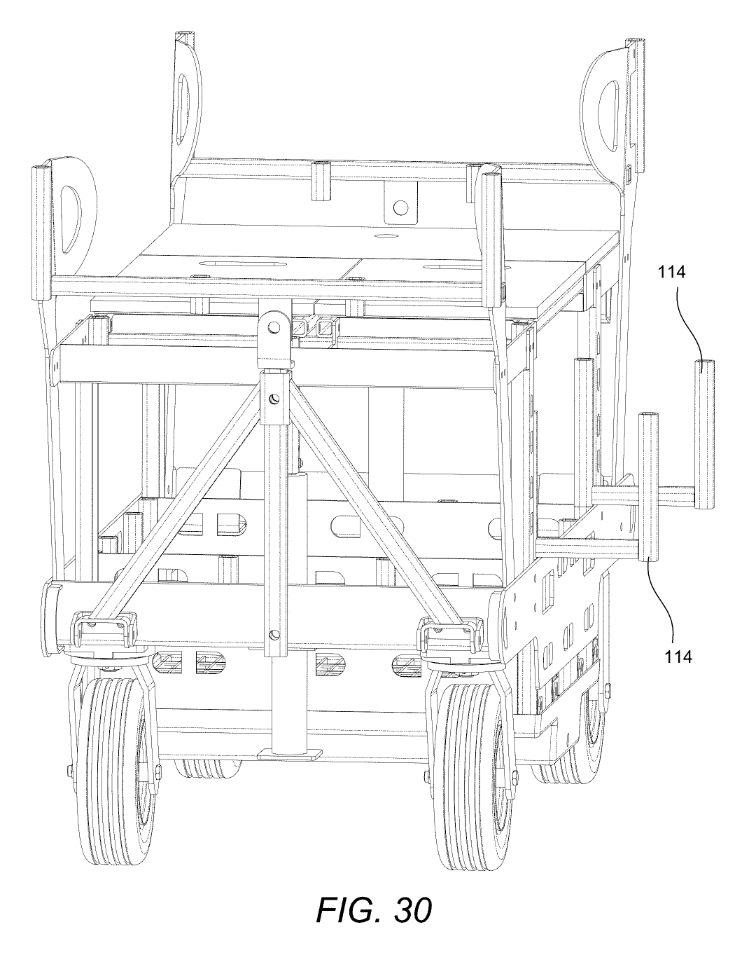

FIG. 30 shows another type of dedicated post, namely a pipe rack post 114 (while the term “pipe rack post” is used herein, it should be understood that the depicted side carrier or something like it can be used to carry objects other than just pipes). A pair of the pipe rack posts 114 is shown in FIG. 30 as being inserted into the supporting ribs 18 on one side of the cart. The cart can be used to carry long items such as pipes, ladders, scaffolding equipment, dimensional lumber and the like in this fashion while still leaving the remainder of the cart open for other needs. If the arms of the pipe rack posts 114 are not tall enough to satisfy the user's needs, standard modular posts 106 may be added on top of each arm of each pipe rack post 114 until a needed height is reached. While the pipe rack posts 114 are shown in a deployed position in FIG. 30, they can easily be turned around one hundred and eighty degrees so that the arms of the pipe racks extend into the interior of the cart (as may be desirable for maneuvering in tight locations).

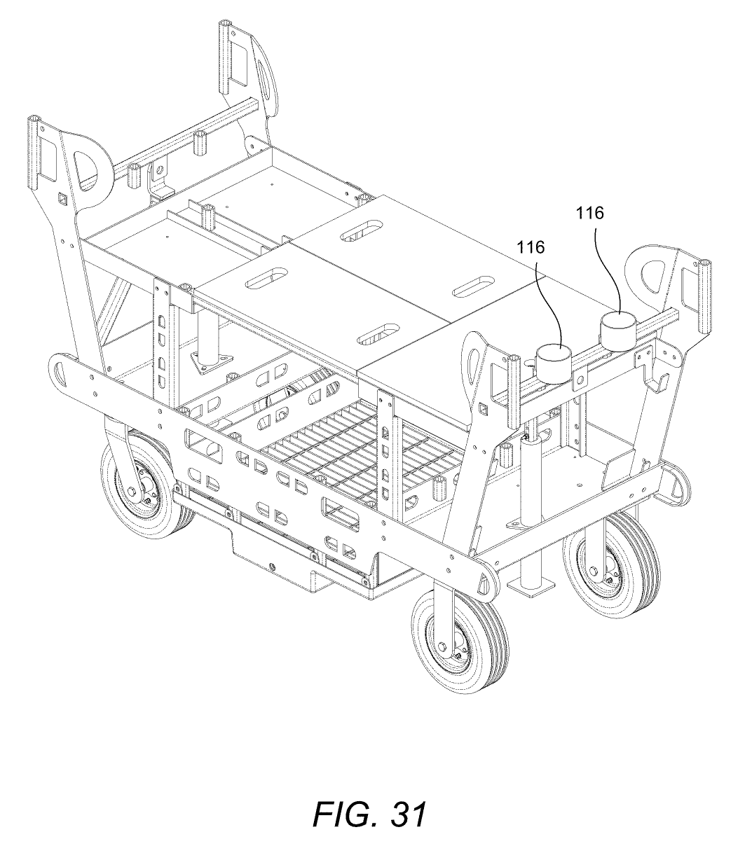

FIG. 31 shows another type of specialized dedicated post, namely a drink holder post 116. The drink holder post 116 may be affixed or inserted into one of the receivers 78 on the horizontal handle 62 as shown in FIG. 31. Alternatively, the drink holder post 116 could be inserted into one of the vertical handles 64 or into one of the receivers 78 of the handle tray 74. This illustrates another layer of the flexibility of the cart. If desired, the drink holder post 116 could have a hole in the bottom to better allow placing a hand drill or any other tool in the drink holder post 116.

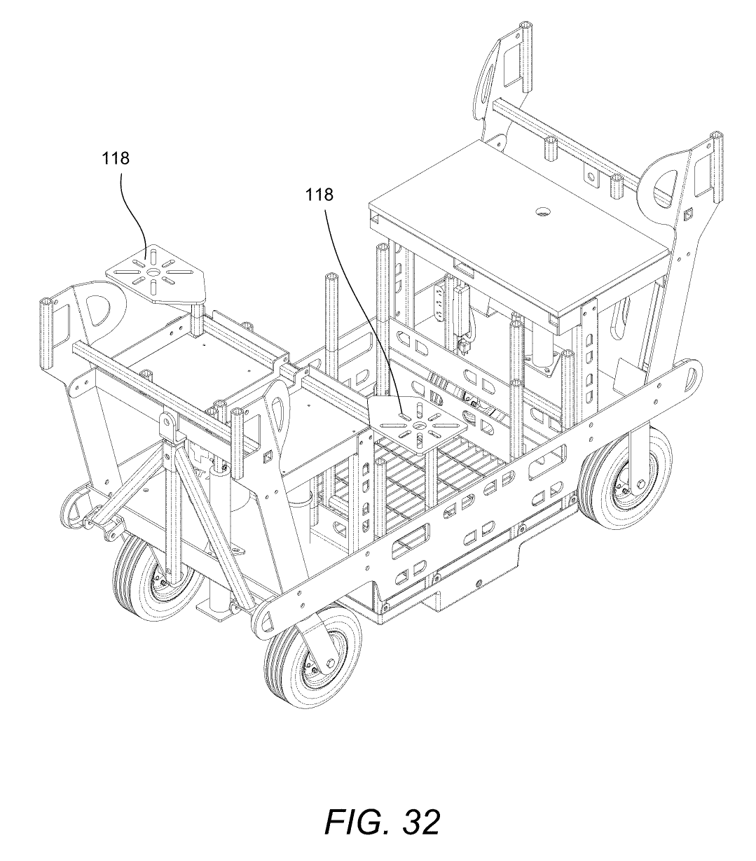

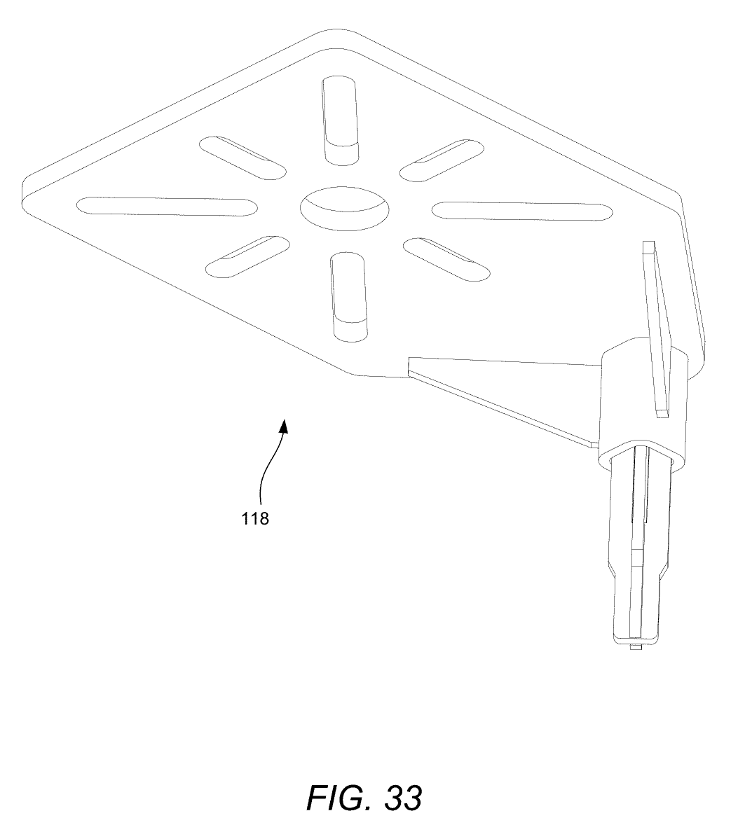

FIGS. 32 and 33 show another specialized post, namely a universal mounting plate 118. The universal mounting plate 118 may be inserted into any receiver 78, other modular post 106 or dedicated post, or vertical handle 64. The universal mounting plate serves as a location to which other devices and tools may be mounted. Non-limiting examples of such devices and tools include vises, pipe vises, bench grinders, other power tools, etc. When the device or tool is not in use, the universal mounting plate to which it is attached may simply be moved into a storage-type location without requiring removal of the tool, and it will be almost instantaneously available again.

Other types of specialized posts are not shown in the Figures. For example, a spare tire post may be provided as a mechanism for securing a spare tire to the cart. The use of a spare tire post allows a position of the spare tire to be readily moved and changed if necessary, and for the spare tire to be readily removed according to the dictates of any moment's particular usage needs of the cart. Another type of specialized post that is not shown in the Figures is a pipe vise plate that may be similar to the universal mounting plate 118, but may utilize a larger receiver 78 and that has a pipe vise mounted thereon. Another type of specialized post is a toolbox tray that is sized and adapted to receive a toolbox thereon with the toolbox secured thereto. As the size of toolboxes varies, the size of the toolbox tray may vary from embodiment to embodiment.

Still another type of specialized post is not shown in the Figures. This specialized post differs from the others as it is formed of an insert member attached to a flag. The flag is narrow and can be inserted flag first into either end of the horizontal handle 62. Because the body of the flag is narrow, two flags can be inserted into each horizontal handle 62 (one from each end) with only minor changes in the effective width of the cart, if any. The flags may be useful, for example, when the cart is being towed, especially if the handle portions have been removed. The flags may be inserted into any of the receivers 78 or vertical handles 64, thereby allowing a driver of a towing vehicle to better be aware of the position of the cart being towed. The foregoing examples of specialized posts are intended to be illustrative, as it is impossible to enumerate every possible specialized post for every particular need.

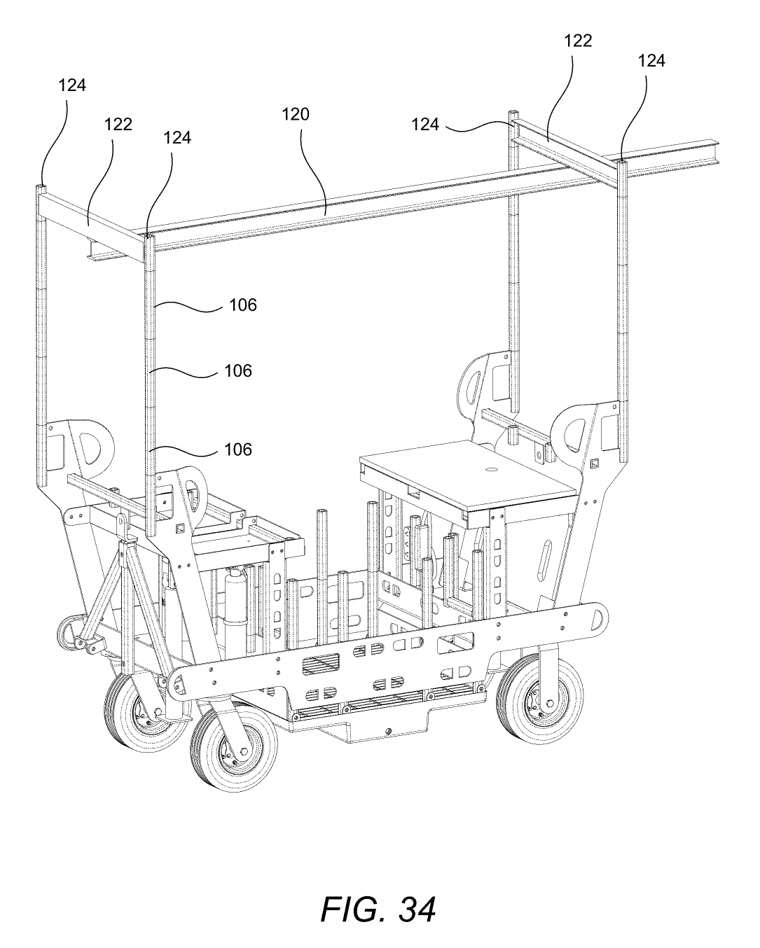

Another function of the modular posts 106 is to build vertical structures that can increase the functionality of the cart. Several exemplary variations on such structures are illustrated in FIGS. 34-37. Of course, while the modular posts 106 are illustrated as being used exclusive of the dedicated posts discussed herein, it should be understood that one or more of the dedicated posts could be incorporated into the illustrated structures. FIG. 34 illustrates a beam trolley hoist attachment that can be selectively added to the cart.

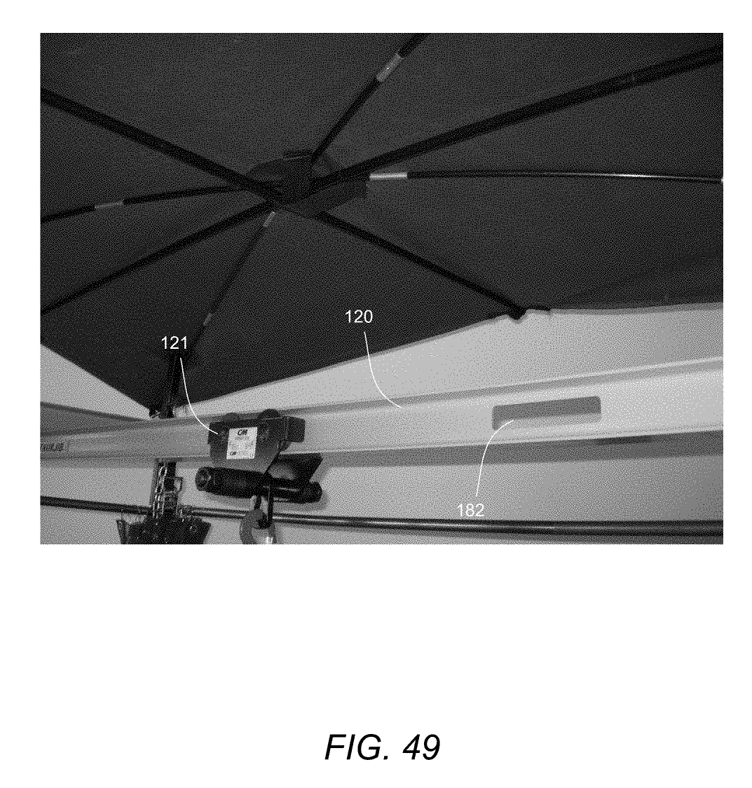

The beam trolley hoist attachment includes a primary beam 120 on which the trolley hoist 121 can run. One embodiment of the trolley hoist 121 may be seen in FIG. 49. As may be seen in FIG. 34, the end of the primary beam 120 extends beyond the end of the cart, so the beam trolley hoist can be used to load and unload items to and from the cart, including to and from the rigid support member 34 or grating deck and to and from any of the small workbench 82 or the large workbench with the table sections 90. If, by way of non-limiting example only, the cart is rated to hold one thousand five hundred pounds, the beam trolley hoist could likely be used to load and unload items weighing as much as five hundred pounds and measuring twenty-four inches on a side (twenty-four inches by twenty-four inches by twenty-four inches).

As the trolley hoist 121 may be used to lift heavy loads at or near the end of the primary beam 120, certain embodiments of the cart may be provided with one or more deployable stabilizing legs (not shown in FIG. 34). The stabilizing leg(s) could be attached at a location or locations on the frame bin 28 of the second handle portion, such as at a location or locations similar to the locations of the hinges 58 shown in and discussed with respect to FIGS. 11 and 12. A variety of deployable stabilizing legs may be used, whereby, when the stabilizing leg or legs is deployed and secured in a deployed position, it/they contact or nearly contact the underlying surface at a location beyond the wheels 30 and serves to minimize or prevent undue tipping of the cart when the trolley hoist 121 is carrying a heavy load.

The stabilizing legs, when not deployed, may be configured to rest at locations designed to minimize interference with other uses of the cart and to be out of the way of legs of users when pushing or pulling the cart by hand. A pinned hinge may be used to secure the stabilizing legs in both deployed and non-deployed positions. The stabilizing legs may also have multiple sections permitting the stabilizing legs to be deployed at differing lengths to allow compensation for variations in the underlying surface.

At locations along the primary beam 120 corresponding to ends of the cart, end support beams 122 are shown, with each end support beam having terminating portions 124 corresponding in structure to the modular posts 106 such that they can be inserted into the modular posts 106 and such that additional modular posts 106 can be inserted therein. The terminating portions 124 correspond in space to the vertical handles 64 of both of the handle portions so as to arrive at the configuration of FIG. 34. As may be seen in FIG. 34, modular posts 106 are also shown inserted into the supporting ribs 18 (such as to help contain cargo), and the cart may be provided with sufficient numbers of modular posts 106 to simultaneously satisfy all needs of the cart (see, for example, the modular post racks 112 shown in FIG. 26, each of which can hold ten modular posts 106).

The beam trolley hoist attachment may weigh less than two hundred pounds or even less than one hundred pounds and may therefore be readily placeable on the cart by two people. The underlying structure of modular posts 106 would be built first, and then the two people would lift up the beam trolley hoist attachment and place it at the top of the structure. Although not specifically shown in FIG. 34, a securing device (e.g. a chain, a cord, a wire, etc.) could be extended between the various terminating portions 124 and corresponding locations on the fixed portions of the cart to ensure that the beam trolley hoist attachment does not inadvertently separate from the cart or posts.

While FIG. 34 shows one specific configuration providing a from-above vertical lift capability to embodiments of the cart, it is envisioned that other configurations of from-above vertical lift capability could be provided, such as embodiments having two primary beams 120 and associated trolley hoists 121. The two primary beams 120 could both extend lengthwise a distance similar to that illustrated in FIG. 34 but rather than run down the center of the cart they could be located on either side of the cart and be separated by a space that could permit an external lifting device and/or loads to be carried to pass vertically between the two primary beams 120.

An additional or alternative vertical lift capability that may be used with embodiments of the invention is a from-below vertical lift capability (not shown). Such a capability may be used in conjunction with a from-above vertical lift capability or may be used independently. Such a capability may be provided by way of a scissor lift, hydraulic lift, or any other lift mechanism, and may be placed on or connected to the cart at the level of the rigid support member 34 or cargo deck, at the level of the top of the modular posts 106 inserted into the supporting ribs 18, at the level of the large workbench, or at any level in between. Controls for the from-below lift capability may be disposed adjacent one of the handles of the cart.

The ability to lift from below may be useful in a variety of situations. For example, it may allow for positioning the cart directly below a piece of equipment to be serviced, and for the piece of equipment to be supported from below by the lift capability. The piece of equipment can then be unfastened or otherwise removed from its normal working position and lowered in a controlled fashion using the from-below lifting capability. The piece of equipment or a replacement piece of equipment can be lifted back up in like fashion and secured in place while being supported by the cart at all times. This may greatly facilitate equipment changes in locations not easily serviceable using existing methods and service equipment.

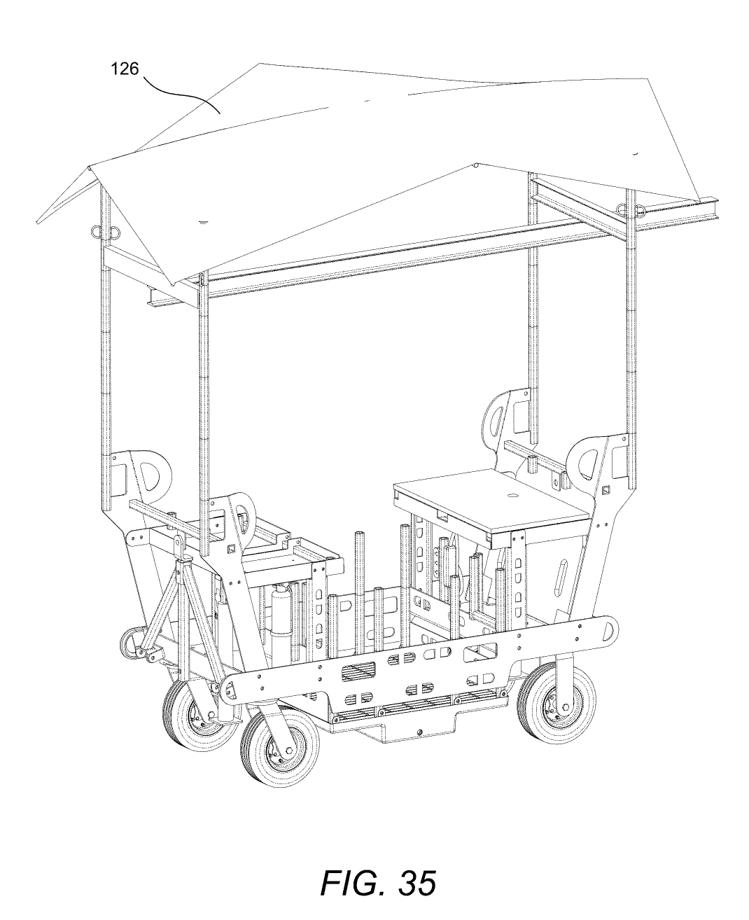

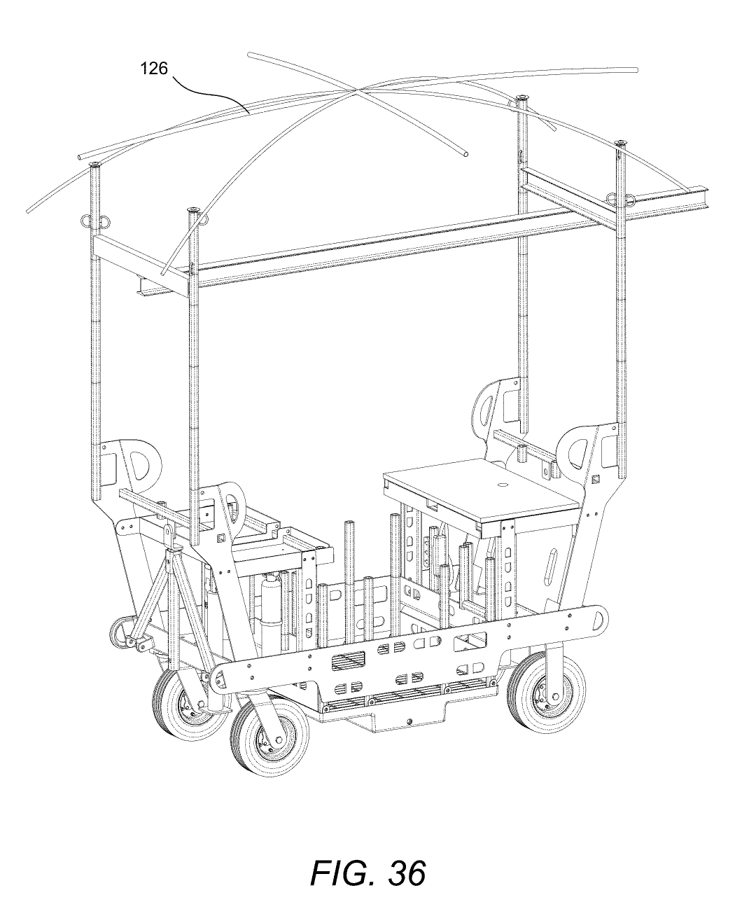

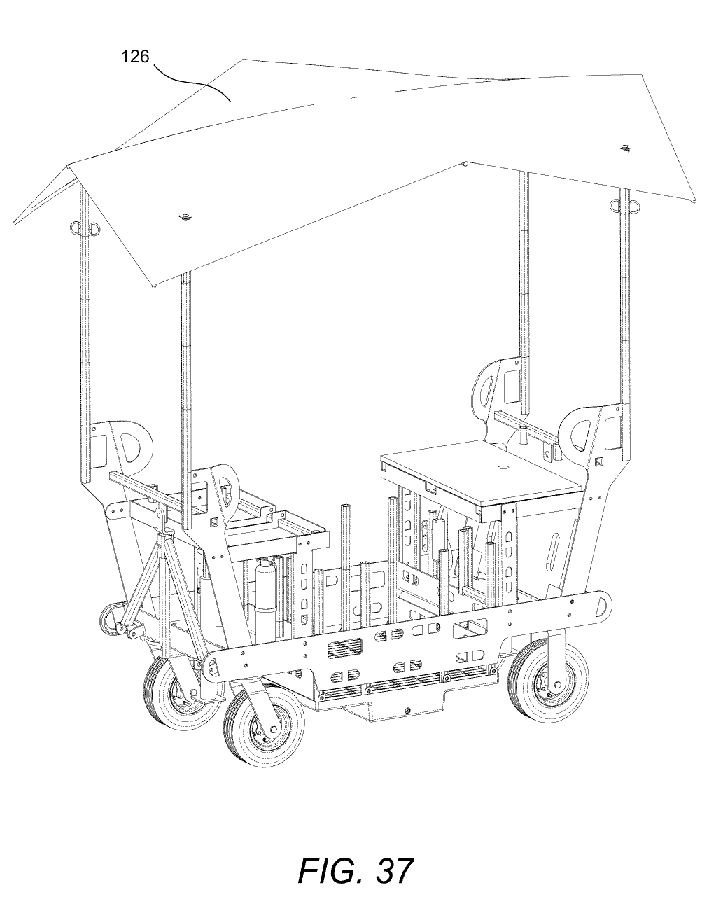

FIGS. 35 and 36 show a further vertical extension of the configuration of FIG. 34, with the addition of a canopy 126 to protect workers and/or equipment from the elements. FIG. 35 shows the canopy 126 itself, while FIG. 36 shows the underlying support structures for clarity. Though not shown, the canopy 126 can be secured to a fixed portion of the cart in a fashion similar to that discussed with respect to the beam trolley hoist to prevent the wind from blowing off the canopy 126. As shown in FIG. 37, the canopy may be used without the beam trolley hoist attachment. Additionally, the height of the beam trolley hoist attachment and/or the canopy 126 can be adjusted higher or lower than what is shown in the Figures as needed.

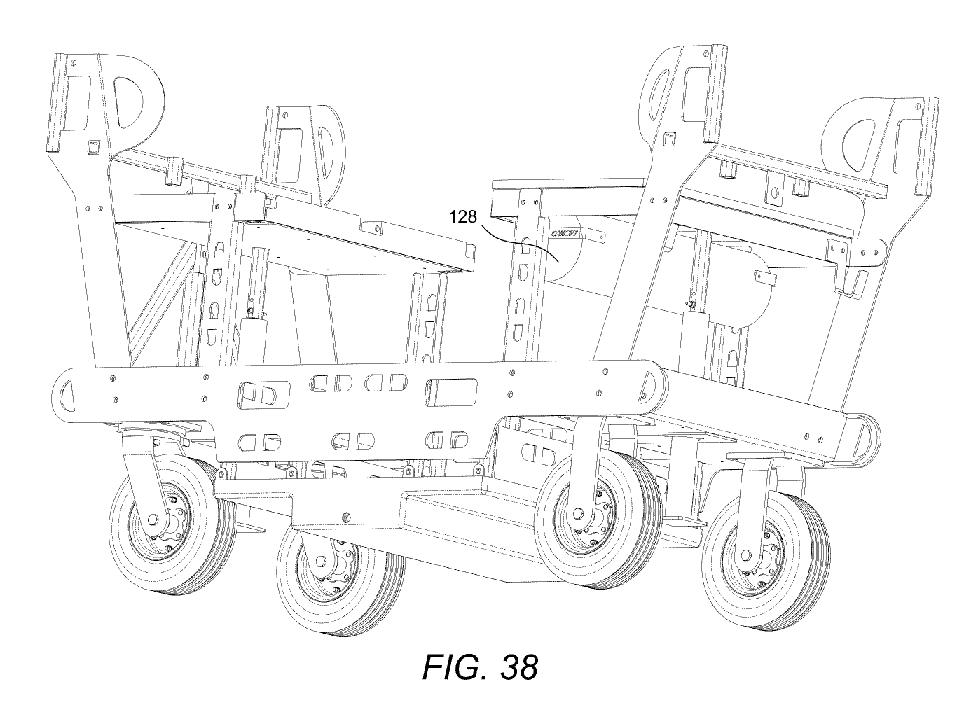

The canopy 126 may be manufactured from fire and UV-resistant materials so as to have a long life. The canopy 126 may also include a frame that is flexible or readily-disassembled so that the canopy can be taken down and only used as needed. FIG. 38 shows a representative canopy storage container 128 and shows how it might be placed on the cart to be readily available. Therefore, the only item that would not be stored on the cart when not in use is the beam trolley hoist.

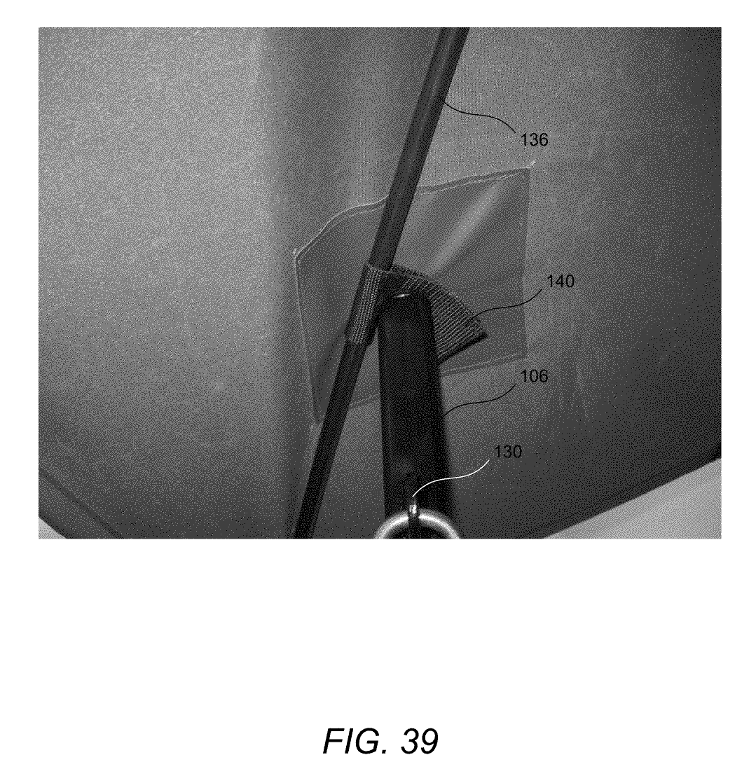

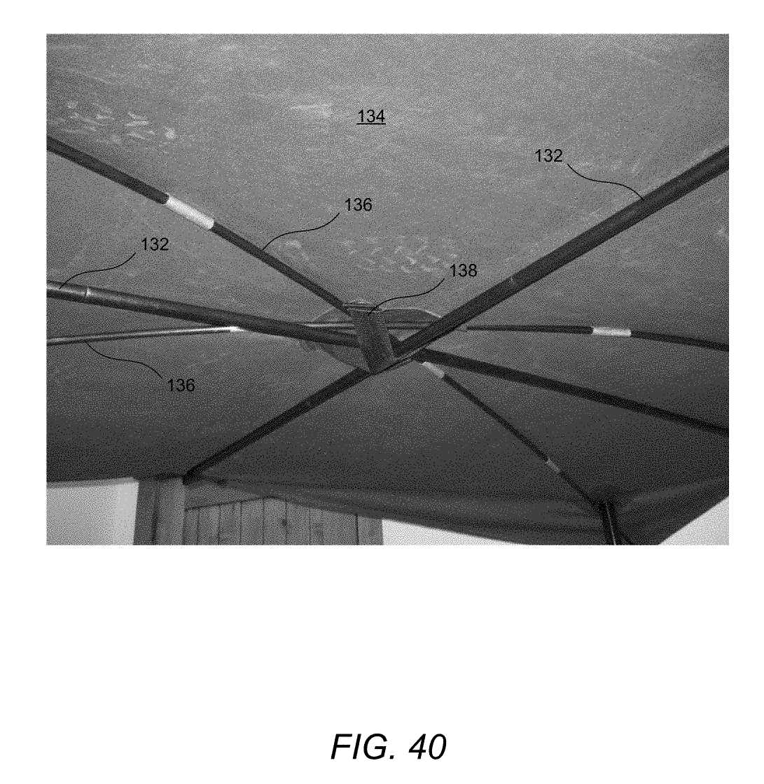

While the canopy 126 may be constructed and assembled in many different ways and may provide a variety of benefits according to each construction and assembly, particular details of one embodiment are illustrated with respect to FIGS. 39-40. It should be understood that different sizes and configurations of the canopy 126 other than the size and configuration shown are possible to satisfy various particular needs. For example, the canopy 126 can be extended in multiple ways to provide additional shelter in rainy environments. Regardless, as shown in FIG. 39, in this embodiment, the uppermost modular post 106 has been modified to include a lateral mounting point 130 to which a safety chain and/or a tensioning device (such as a ratcheting tie-down) may be attached to secure the canopy 126 and the entire upper assembly to the main body of the cart, whereby the canopy 126 and/or any other structures are not prone to be lifted from the cart.

Where the uppermost modular post 106 meets the material of the canopy 126, the canopy 126 may be reinforced as is known in the art. Additionally, at this location, certain features may be incorporated that help ensure that the fabric or other material or the canopy 126 remains snugly retained against a supporting structure of the canopy 126. As may be seen in FIG. 40, this embodiment of the canopy includes two sets of crossing support members. A first set of heavier-duty support members 132 extend from midpoints of the sides of the canopy material 134, crossing at a midpoint of the canopy material 134, where they are secured to the canopy material 134, along with a second set of lighter-duty support members 136, such as by straps 138.

As illustrated in FIG. 40, the lighter-duty support members 136 extend diagonally across the canopy material 134 from corner to corner, again crossing in the middle of the canopy 126. In the illustrated embodiment, it can be seen that the lighter-duty support members 136 pass above the heavier-duty support members 132, and are therefore in between the heavier-duty support members 132 and the canopy material 134. It has been found that this particular arrangement best retains the canopy material 134 in a taught arrangement on the support structure. The straps 138 help ensure that the canopy material 134 is secured against unwanted motion at the center of the canopy 126. Additionally, at the end of each of the support members 132 and 136, the canopy material 134 is secured to the respective support members 132 and 136 and is reinforced, according to methods known in the art.

While this configuration secures the center and ends of the canopy material 134 against unwanted motion, the embodiment illustrated in FIGS. 39 and 40 includes additional features to further secure the canopy material 134. It should be noted from FIGS. 35-37 and 39-40 that the canopy material 134 extends beyond a longitudinal location of the connection between the canopy 126 and the modular posts 106, so as to provide better shielding from the elements. The canopy material 134 is reinforced at this location as discussed above, but other features ensure that the canopy 126 remains securely fastened at that location without undue vibration and/or sagging. Such features are shown in more detail in FIG. 39.

Specifically, at the location of joining of the canopy 126 to the modular post 106, the canopy 126 is provided with a reinforcing and retaining strap 140. The strap 140 is attached to the canopy material 134 at a location where a fastener passes through the canopy material 134 (either from above to be secured to the modular post 106 or from below as part of the modular post 106 to be secured to a retaining element such as a nut and washer). As the canopy 126 is assembled and mounted to the modular post 106, the strap 140 is wrapped around the lighter-duty support member 136 and then the fastener is passed through the strap 140 twice such that the lighter-duty support member 136 is retained proximate the tip of the modular post 106 at all times. This ensures that any force that is imparted to the canopy 126 (such as by wind, etc.) does not cause large scale movement of the canopy material 134, as the strap 140 retains the lighter-duty support members 136 in close proximity to the tips of the modular posts 106 (which are secured against movement as described above).

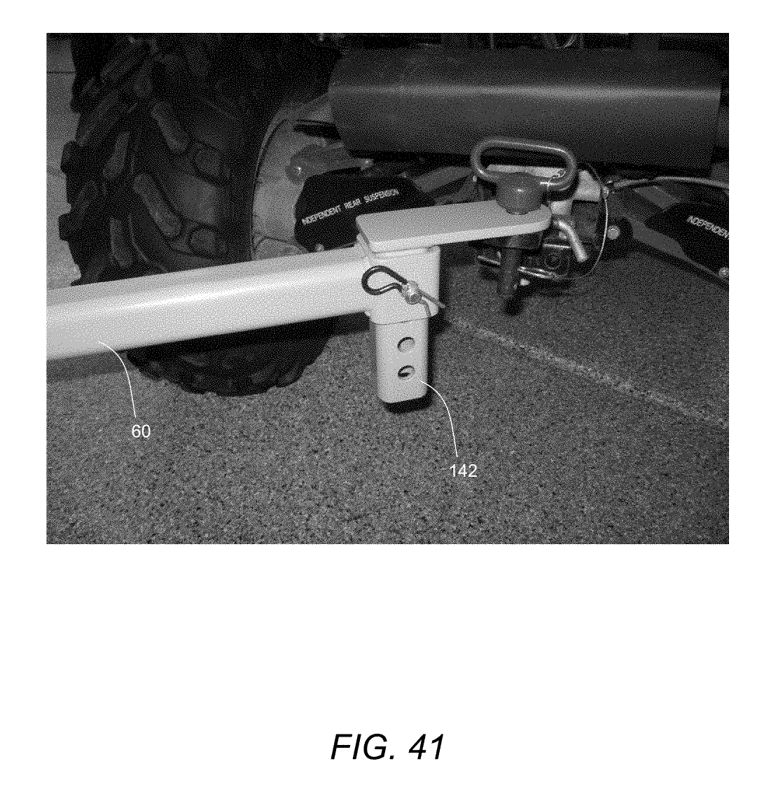

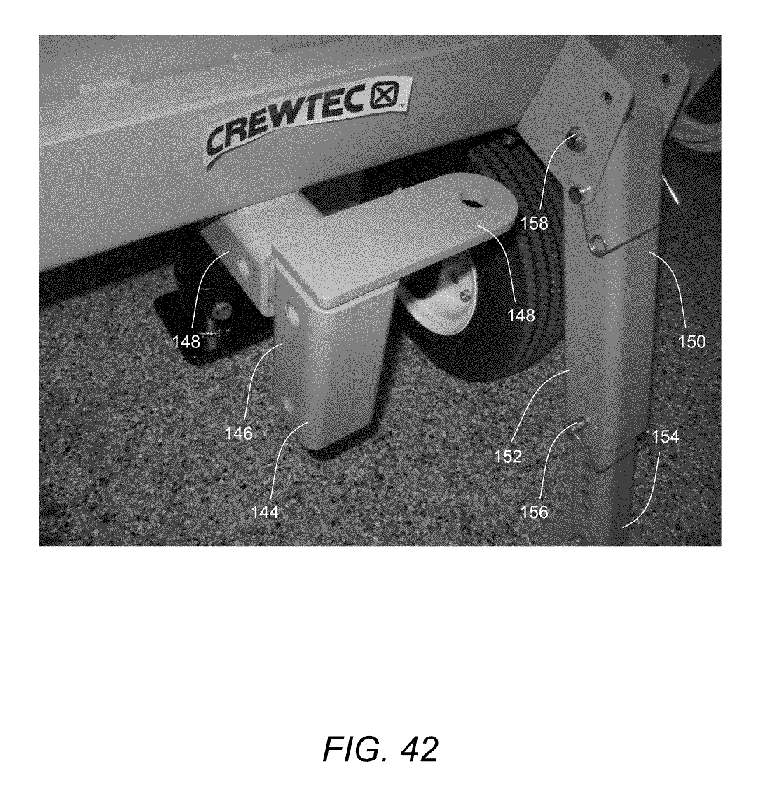

FIGS. 41 and 42 show features of certain embodiments that may facilitate towing features of the cart. Specifically, FIG. 41 shows an embodiment of the trailer hitch 56, and specifically the tongue 60 of the trailer hitch 56. In this embodiment, the end of the tongue 60 is provided with an adjustable tongue insert 142 that can be adjusted to any of a variety of heights using a plurality of adjustment holes provided in the tongue insert 142. This allows the trailer hitch 56 to be adjusted to match the towing height of any of a large variety of towing vehicles while keeping the trailer hitch 56 near horizontal. In FIG. 41, the tongue insert 142 is shown inserted into the tongue 60 from above, but it should also be understood that the tongue insert 142 could be inserted into the tongue 60 from below, providing a connection to towing vehicles having additional (lower) towing levels.

FIG. 42 shows a rear towing element 144 that may be attached at a rear location on the cart. A rear towing element 144 such as shown in FIG. 42 allows an additional towable element to be towed behind the cart in daisy-chain fashion, reducing the time necessary to transport necessary equipment and materials from location to location. The additional towable element may be an additional cart such as described herein, or it may be any other towable element including other types of carts, trailers, and the like. The rear towing element 144 shown in FIG. 42 includes several features permitting significant adjustability of the towing height of the rear towing element 144 similar in fashion to that seen in FIG. 41 for the tongue insert 142.

For example, the rear towing element 144 includes several components, which may optionally be removed for storage or may remain mounted at the rear of the cart if desired. The rear towing element first includes a receiver 146 that may be attached to the trailer such as by being inserted into a receiver mount 148 as shown in FIG. 42. As may be appreciated by reference to FIG. 42, the receiver 146 may optionally be formed so as to be mountable in multiple positions (e.g. with a long portion down or up) so as to provide further flexibility in changing the towing height of the rear towing element 144. A hitch insert 148 is insertable into the receiver 146 and may include multiple holes (as with the tongue insert 142 shown in FIG. 41) to provide various height adjustments. As with the tongue insert 142, the hitch insert 148 may be inserted into the receiver 146 from above or from below to further increase the potential height adjustments of the towing height. When the rear towing element 144 is not needed for towing, the hitch insert 148 may be inserted as shown in FIG. 42, pointing toward the side of the cart, so as to reduce the extent to which the hitch insert 148 extends from the cart and to thus prevent unwanted contact with the hitch insert 148.

As discussed above, as the trolley hoist 121 may be used to lift heavy loads at or near the end of the primary beam 120, certain embodiments of the cart may be provided with one or more deployable stabilizing legs 150, one embodiment of which may be seen in FIG. 42. The stabilizing leg 150 is attached on the frame bin 28 adjacent the rear towing element 144 and near the side of the cart (an additional stabilizing leg 150 is located opposite the rear towing element 144 outside the Figure). When the stabilizing leg 150 is deployed and secured in a deployed position as shown in FIG. 42, it contacts or nearly contacts the underlying surface at a location beyond the wheels 30 and serves to minimize or prevent undue tipping of the cart when the trolley hoist 121 is carrying a heavy load.

As may be appreciated from FIG. 42, the stabilizing leg 150 includes a receiving portion 152 that receives an insert portion 154 therein. Both the receiving portion 152 and the insert portion 154 include holes permitting insertion of a pin 156 therethrough that locks the relative extended position of the insert portion 154 with respect to the receiving portion 152, and thereby the length of the stabilizing leg 150. To provide maximum fineness of the changes in length possible of the stabilizing leg 150, the spacing of the holes in the receiving portion 152 may differ from the spacing of the holes in the insert portion 154, and the respective holes chosen for inserting the pin 156 may be chosen to achieve a best possible length of the stabilizing leg 150.

The stabilizing legs 150, when not deployed, may be configured to rest upward and out of the way so as to minimize interference with other uses of the cart. A pinned hinge 158 may be used to secure the stabilizing legs in both deployed and non-deployed positions, as shown in FIG. 42.

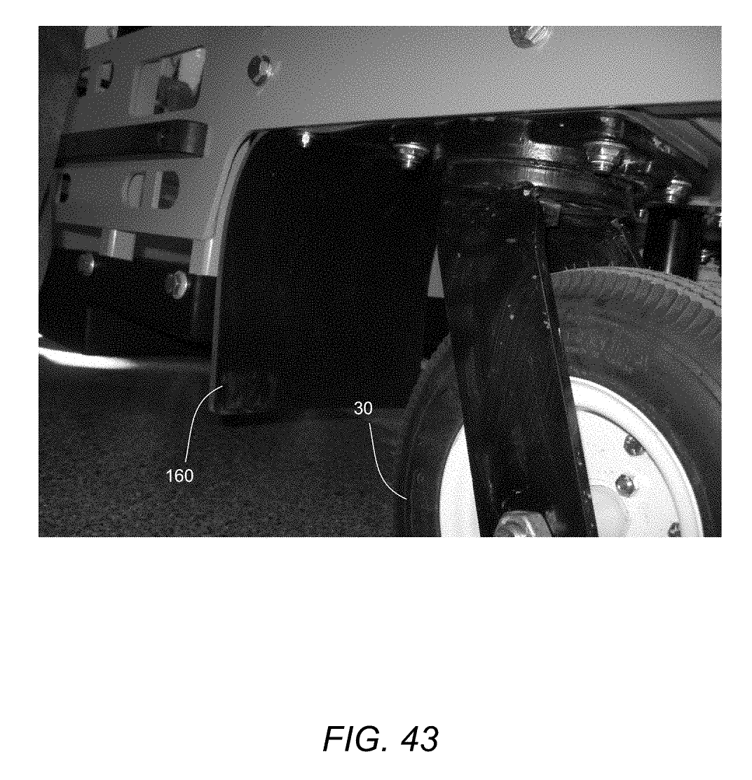

As may be appreciated from the description above, the cart may be towed at appreciable rates of speed. As may be appreciated, any vehicle with wheels moving at an appreciable rate of speed may have materials from the underlying surface tossed upward by the wheels. Thus, some vehicles designed for high speed use may include mud flaps to minimize travel of any materials tossed up by the wheels. Embodiments of the cart utilize this principle and include a combined mud flap/shock absorber 160 as shown in FIG. 43. The mud flap/shock absorber 160 shown in FIG. 43 combines features of a mud flap with features of a shock absorber, thereby preventing mud and other material from being flung into areas of the cart where it is not wanted while providing some additional shock absorbing at the wheels 30 and casters 32.

The mud flap/shock absorber 160 is formed out of a piece of rubber that is mounted between the frame of the cart and the wheel 30 as shown in FIG. 43, thereby providing some additional shock absorbing between the frame of the cart and the wheel 30. The piece of rubber then extends horizontally toward the center of the cart and then downward as shown to provide a mud flap. While it is envisioned that any of a variety of materials and material thicknesses may be used to achieve desired mud flap and shock absorbing characteristics, it has been found that a sheet of sixty durometer rubber serves well as the mud flap/shock absorber 160.

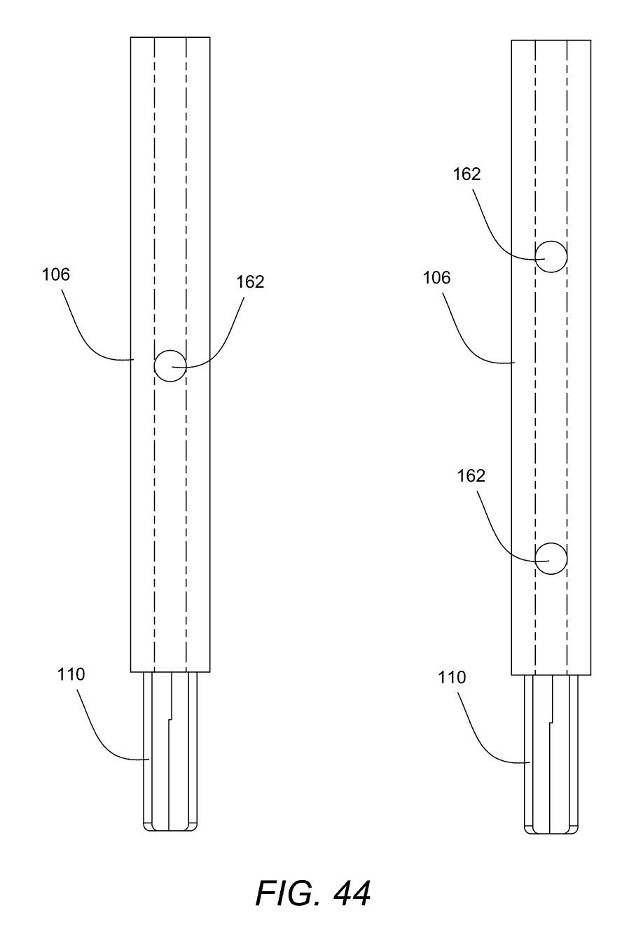

In certain embodiments, a modified modular post 106 may be provided that potentially greatly extends the functionality of the cart. Representative depictions of the modified modular posts 106 are shown in FIG. 44. These modular posts 106 include one or more horizontal post holes 162. Each horizontal post hole 162 passes entirely through the modular post 106 and is adapted to receive a fastener passed therethrough. Although not specifically visible in the face-on views of FIG. 4, orthogonal horizontal post holes 162 may pass in both directions through the modular posts 106 at identical, similar, or adjacent locations along the length of the modular posts 106. As may be seen in FIG. 4, the one or more horizontal post holes 162 may be located at essentially any location along the length of the modular post 106. The strength of the modular post 106 is not significantly impacted by the inclusion of the horizontal post holes 162. As may be appreciated, horizontal post holes 162 may be provided in both arms of the pipe rack post 114 shown in FIG. 30.

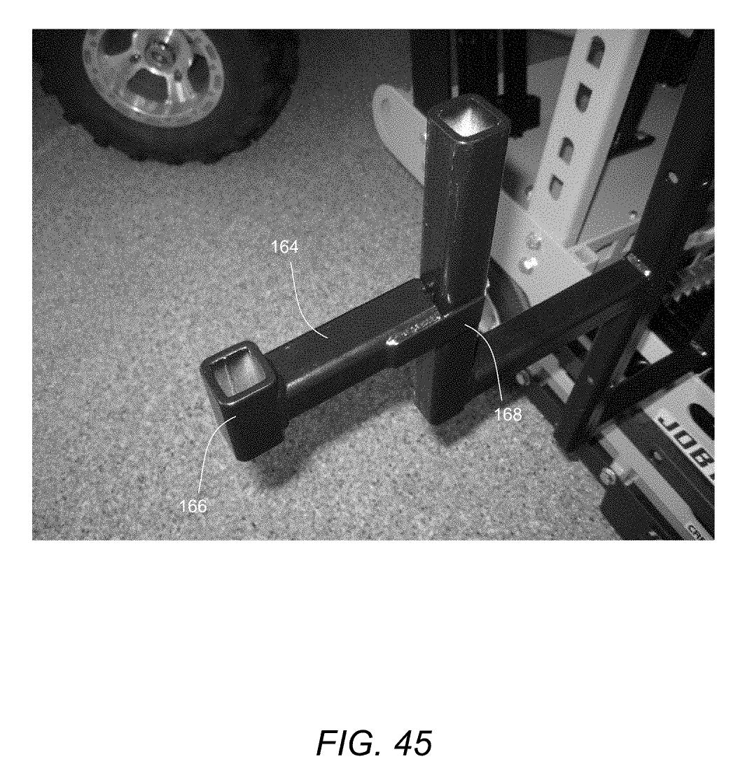

The horizontal post holes 162 permit the attachment of a variety of additional cart elements to the cart, potentially greatly extending the functionality of the cart. As seen in FIG. 45, one element that may be attached to the modular post 106 using the horizontal post hole 162 is a horizontal extender 164. The horizontal extender 164 may be manufactured to extend horizontally any desired length. The horizontal extender 164 has a post receiver 166 mounted on a distal end of the horizontal extender 164. The post receiver 166 can accept any properly-sized modular post 106, permitting essentially limitless extension of the modular post system. The horizontal extender 164 also includes a tab 168 that extends alongside the side of the modular post 106 to which the horizontal extender 164 is attached, thereby preventing unwanted rotation of the horizontal extender 164 and keeping the post receiver 166 in an approximately-vertical position.

Elements such as the horizontal extender 164 may be used to further modularize and customize a cart's configuration. For example, the cart may be modified to permit carrying of a bicycle on the side of the cart, even if pipes or other materials are being carried in the pipe rack posts 114. Similarly, a modular post similar in appearance to the universal mounting plate 118 shown in FIG. 33 but having a different pattern of holes may be used as a tool holder whereby individual tools are inserted into the various holes from above and are kept in the tool holder by the force of gravity. The tool holder may be readily moved from position to position according to the location of any receiver 78 or post receiver 166, or a horizontal extender 164 can be readily moved to a desired location on demand using the horizontal post holes 162.

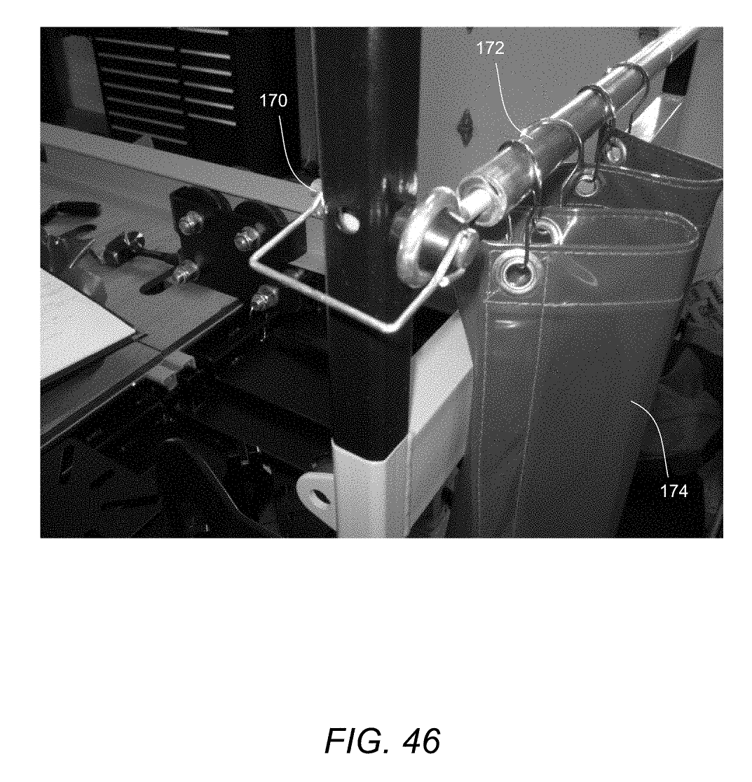

The horizontal post holes 162 can be used to attach other elements to the cart. For example, it may be useful to attach a welding curtain or the like along several sides of the cart to shield either others' eyes from welding occurring on the cart or to provide shielding from wind and/or rain to the work surface of the cart and to the cart's user. FIG. 46 illustrates how this can be obtained using the horizontal post holes 162. In FIG. 46, a curtain rod pin 170 passes through the horizontal post hole 162 and is attached to a curtain rod 172. The curtain rod 172 may have multiple sections that can be disassembled to fit in a small space, and has a welding curtain 174 suspended thereon. Welding curtains 174 may be hung on multiple sides of the cart in moments using configuration such as those shown in FIG. 46, and can be left on essentially permanently if desired, and the welding curtains 174 may be secured adjacent a tower of modular posts 106 for transport purposes.

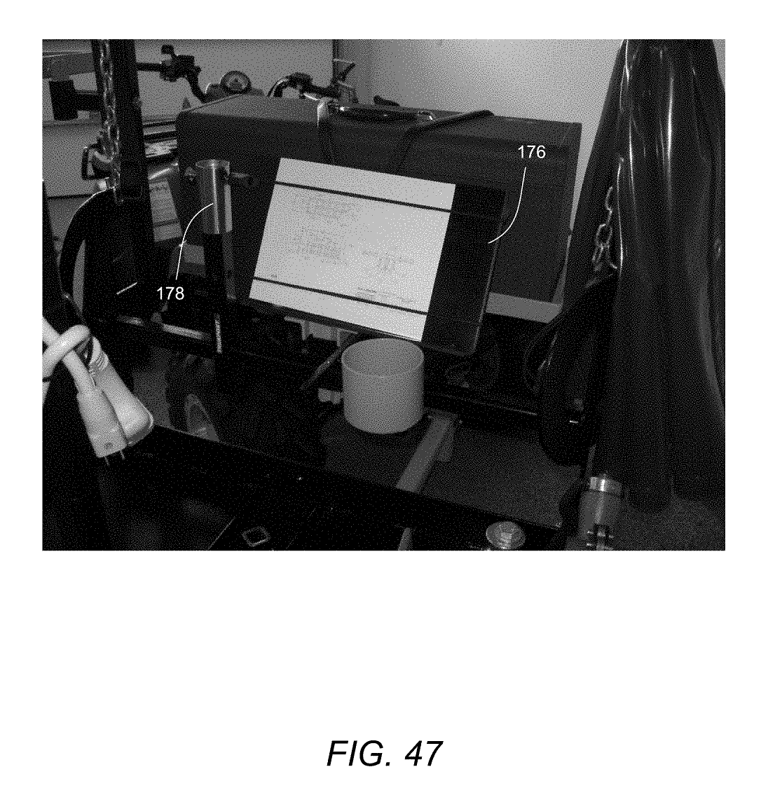

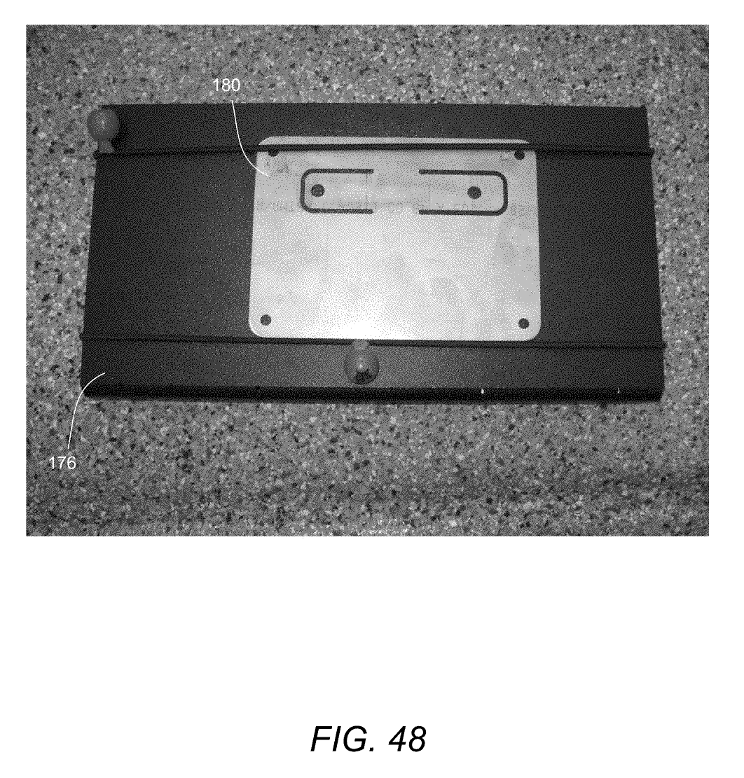

FIGS. 47 and 48 show an additional specialized post that may be used in certain embodiments. This specialized post is a clipboard 176 or other document holder. The clipboard 176 includes a mounting sleeve 178 that is sized to pass over the top of a modular post 160, such that the mounting sleeve 178 (and thus the clipboard 176) may be mounted in any rotational orientation so as to be clearly visible in a needed direction. The mounting sleeve 178 includes a threaded fastener passing through the mounting sleeve 178 such that the threaded fastener may be tightened to fix the mounting sleeve 178 at a particular rotational orientation. FIG. 48 shows a mounting plate 180 that is attached between the main surface of the clipboard 178 and the mounting sleeve with the threaded fastener such that the main surface of the clipboard 176 may be rotated up and down to a desired position. The longer of the two tabs of the mounting plate shown in FIG. 48 is bent at the distal end so as to engage an end of the threaded fastener and prevent undesired rotation of the threaded fastener during tightening of a tightening element threaded thereon.

FIG. 49 shows a version of the primary beam 120, with the trolley hoist 121 attached thereto. The additional feature exemplified by FIG. 49 is the addition of forklift receiving holes 182 passing through the primary beam 120 (one forklift receiving hole 182 is hidden by the trolley hoist 121 in FIG. 49). The forklift receiving holes 182 facilitate the use of a forklift to lift the beam trolley hoist attachment to and from the cart. Because the primary beam 120 extends farther on one end of the cart than on the other end, the center of mass of the beam trolley hoist attachment may not be located at a position corresponding to the center of the cart. Therefore, the location of the forklift receiving holes 182 may be offset accordingly so as to correspond to a center of gravity of the beam trolley hoist attachment.

As discussed herein, the embodiments of the cart may be used and configured in a wide variety of ways to suit particular applications. A few of these configurations are effectively illustrated in the drawings discussed herein. It should be understood from these views and the accompanying discussion that other configurations are embraced to satisfy a particular need, and thus these views and configurations are not intended to be limiting. Additionally, while some embodiments of the cart may be sold including all the various features and may then assume any configuration using fewer features as desired, it is anticipated that embodiments of the cart may be manufactured and sold with fewer features/options/parts as desired. Thus, each possible configuration may also represent a possible embodiment of the cart.

It is envisioned that some configurations (e.g. one of several possible trailer-only configurations) may be particularly useful in distribution of newly-arriving equipment and materials around a worksite. For example, for a particular worksite, it may be desirable to avoid having delivery vehicles drive around the entire worksite to unload loads, as drivers of such vehicles may be unfamiliar with the worksite or dangerous zones thereof, and there may be risks associated (such as spark-caused fires, etc.) with allowing such deliveries. Therefore, the delivery vehicle may deliver newly-arriving equipment and materials to a warehouse near a border of the worksite. The newly-arriving equipment and materials may be on pallets and may be removed therefrom at the warehouse for distribution to the location(s) where it is needed at the worksite.

The equipment and materials then need to be distributed from the warehouse to locations, such as workshops, distributed around the worksite. A trailer-only configuration may be used for such distribution, using a forklift, golf cart, truck, or other towing vehicle to safely distribute loads from the warehouse to the workshops with minimal risk of damage to the equipment and materials. As there are rarely concerns regarding spills and leaks with new equipment, a configuration lacking the containment pan 40 may be used for such distribution. At the workshops, the materials and/or equipment may be further prepared for use at locations surrounding the workshops, after which the equipment and/or materials can be delivered to locations where it is needed using different embodiments or configurations of the cart, such as configurations for pushing, crane-assisted delivery, forklift delivery, and delivery by elevator and the like.

As mentioned, the various embodiments of the cart may be used in a wide variety of situations and applications, and may be varied from the specifically-discussed embodiments shown herein to match a desired application. Additionally, as mentioned herein, one industry where it is envisioned that embodiments of the cart may be useful is the oil refining and processing industries. As is well known, those industries involve the movement of large pieces of equipment and parts in often-constrained environments. Some of such equipment and parts may be relatively delicate. In such an environment, it often becomes difficult to properly and safely locate items that may weigh hundreds of pounds in locations where they are needed. For example, if a valve is to be replaced, it must be removed and transported out of its location in the refining or processing unit, and a new valve transported in to that location and installed. The complex multi-story nature of such environments often further complicates these procedures.

Embodiments of the cart facilitate such replacement procedures. In the above example, the cart may be placed, empty, underneath the valve to be replaced, and the valve may be removed and lowered directly into the cart, such as with come-alongs or similar devices or manually, if necessary. The cart may then be rolled to a location where it is accessible to a crane, and may be lifted from one location to another by the crane. The cart may then be rolled to a different location, and may there be collected by a forklift and moved to still a different location, where the cart may be rolled and possibly towed to still a further location. Alternatively at any step or additionally, the cart may be rolled to an elevator for elevator transport between different vertical locations. Meanwhile, any oil or other chemicals in or on the valve are collected by the containment pan 40 for later safe disposal/removal.

The new valve (by way of using a new cart, or using the original cart unloaded and reloaded with the new valve) is delivered to the installation location, such as in a reverse transportation order and may be lifted directly into place using the come-alongs or other similar devices (not shown) or manually. In this way, a valve that might weigh hundreds of pounds need not ever be physically lifted and maneuvered by workers' brute force and/or carrying, or only minimally so, but is instead easily moved using the cart.

It should be understood that the cart may be manufactured of any materials suited for the specific needs of a given situation. In addition, the cart may be made of a weight and durability for a variety of situations. Thus, the cart may be manufactured as a lighter-duty cart where a heavy-duty cart is not needed, and may be manufactured as a heavier-duty cart where needed. As three non-limiting examples, specifications for three classes of carts may be contemplated, a heavy-duty class cart, a medium-duty class cart, and a light-duty class cart.

The heavy-duty class cart, for example, may be rated to carry heavier loads and may have larger wheels 30 and casters 32, and a larger total length and width. It may be common for such a cart to be pushed and/or pulled by approximately four people. Additionally, the heavy-duty cart may be commonly transported by crane, forklift, and towing.

The medium-duty class cart, in contrast, may be rated to carry intermediate loads. This cart may have somewhat smaller wheels 30 and casters 32, an intermediate length and width. It may be common for such a cart to be pushed and/or pulled by approximately two people. In addition to being commonly transported by crane, forklift, and towing, this cart might commonly be found in elevators and along catwalks that might be unmanageable using the heavy-duty cart, even if the heavy-duty cart is designed to enter most locations.

The light-duty class cart may be rated to carry lighter loads (as desired). This cart may have smaller wheels 30 and casters 32, and a shorter length and width. It may be common for such a cart to be pushed and/or pulled by a single person in many instances. In addition to being used in conjunction with cranes, forklifts, towing, elevators, and pushing, it may be especially suited for use on catwalks (e.g. catwalks not compliant with OSHA regulations) and in other tight spaces which heavier-duty carts may be unable to access.

While several classes of carts are described in the immediately-preceding paragraphs, it should be understood that the described carts are only illustrative of the various classes and duties of carts that may be provided in conjunction with certain embodiments of the invention. Other carts comporting with the spirit of the appended claims are also embraced as embodiments of the invention. Components of the various embodiments may include or be made of a variety of materials such as coated and non-coated metals and alloys thereof, plastics, composites, and various types of wood. The uses of various materials may be varied based on the duty requirements of each embodiment, the anticipated uses and environments, and for any other reasons.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A cart comprising:
a cart frame comprising a pair of elongate side frame members;
a cargo-supporting framework comprising:
a plurality of supporting ribs, each supporting rib being connected to and extending approximately downward from one side frame member; and
a horizontal support structure interconnecting the plurality of supporting ribs; and
a rigid support member resting on and supported by the horizontal support structure.

2. A cart as recited in claim 1, wherein the side frame members include openings configured to receive forks of a forklift to permit lifting of the cart by the forklift.

3. A cart as recited in claim 2, wherein the cart comprises openings configured to be attached to a crane.

4. A cart as recited in claim 1, further comprising a containment pan connected to and suspended under the cargo-supporting framework.

5. A cart as recited in claim 4, wherein the containment pan is configured so that it can be disconnected from the cargo-supporting framework, lowered to an underlying surface, and slidingly removed from under the cart without lifting the cart above the underlying surface.

6. A cart as recited in claim 4, wherein the containment pan comprises a stepped bottom having a lower central portion flanked by higher side portions, and wherein the higher side portions are disposed to receive forks of a forklift to permit lifting of the cart by the forklift and transmit lifting forces applied by the forks to portions of the cargo-supporting framework directly above the higher side portions.

7. A cart as recited in claim 1, further comprising a frame bin attached to and extending between the side frame members proximate a handle of the cart.

8. A cart as recited in claim 1, further comprising a foldable and extendible trailer hitch connected to the cart and configured to permit towing of the cart by a vehicle.

9. A cart as recited in claim 1, further comprising one of a handle tray and a small workbench attached proximate a handle of the cart.

10. A cart as recited in claim 1, further comprising posts that may optionally be inserted into receivers on the cart and that serve to contain large and/or bulky loads within the cart.

11. A cart as recited in claim 1, further comprising:
handles disposed on either end of the cart; and
a removable workbench extending at least partially between the handles.

12. A cart as recited in claim 1, wherein the cart has a length and a width chosen to permit the cart to maneuver on a standard industrial catwalk and to fit within an elevator.

13. A cart as recited in claim 1, wherein the cart comprises a removable beam trolley hoist attachment configured to lift items to and from a location past one end of the cart from and to a location on the cart.

14. A cart as recited in claim 1, wherein the cart comprises a removable canopy that provides protection from the elements when deployed on and above the cart.

15. A cart as recited in claim 1, wherein the cart comprises a plurality of interchangeable posts, each post comprising:
an elongate body;
a receiver formed in one end of the elongate body; and
an insert member disposed at an opposite end of the elongate body and configured to be inserted into a corresponding receiver of other posts.

16. A cart as recited in claim 15, wherein at least one of the posts is a dedicated post having a dedicated function in addition to any vertical stacking structural function.

17. A cart as recited in claim 16, where the dedicated function is selected from the group of:
attaching a first aid kit to a variable location on the cart;
attaching a power bar to a variable location on the cart;
attaching a work light to a variable location on the cart;
attaching a universal mounting plate to a variable location on the cart;
attaching a tool mounted on a mounting plate to a variable location on the cart;
attaching a fire extinguisher to variable location on the cart;
attaching a pipe rack to a variable location on the cart;
attaching a drink holder to a variable location on the cart; and
attaching any other device secured to the dedicated post to a variable location on the cart.

18. A cart comprising:
a cargo-supporting framework; and
a containment pan connected to and suspended under the cargo-supporting framework.

19. A cart comprising:
a frame comprising a pair of elongate side frame members;
wherein the side frame members include openings configured to receive forks of a forklift to permit lifting of the cart by the forklift.

20. A cart comprising:
a handle at an ergonomic height configured to permit pushing or pulling of the cart by hand; and
a foldable and extendible trailer hitch connected to the cart and configured to permit towing of the cart by a vehicle.
